(19) United States
(12) Patent Application Publication
(10) Pub. No.: US 2019/0014003 A1
(43) Pub. Date: Jan. 10, 2019

(54) DYNAMIC CHAIN CONFIGURATION SELECTION

(71) Applicant: QUALCOMM Incorporated, San Diego, CA (US)

(72) Inventors: Sandip HomChaudhuri, San Jose, CA (US); Louay Jalloul, San Jose, CA (US); Pradeep Kumar Yenganti, Fremont, CA (US)

(21) Appl. No.: 16/030,638

(22) Filed: Jul. 9, 2018

Related U.S. Application Data
(60) Provisional application No. 62/530,767, filed on Jul. 10, 2017.

(51) Int. Cl. H04L 12/24; H04W 24/08; H04B 7/0413; H04B 17/336

(52) U.S. Cl. CPC H04L 41/0816; H04B 17/336; H04B 7/0413; H04W 24/08

(57) ABSTRACT

Methods, systems, and devices for wireless communication are described. A wireless device (e.g., an access point or a station) capable of supporting multiple chain configuration modes may dynamically select a chain configuration mode via channel analysis and energy efficiency analysis. A wireless device may monitor traffic on a wireless channel using a first chain configuration mode. The wireless device may determine an energy value associated with monitoring the traffic using the first (e.g., single) chain configuration, and further determine or infer an energy value associated with monitoring the traffic using a second (e.g., multi) chain configuration. The wireless device may perform a channel metric computation on the traffic (e.g., perform a QR decomposition of a channel matrix associated with the monitored traffic). The wireless device may then switch or select a chain configuration mode for operation based on a comparison between the determined energy values and the channel metric computation.

### CROSS REFERENCES

The present Application for Patent claims the benefit of U.S. Provisional Patent Application No. 62/530,767 by HomChaudhuri, et al., entitled “DYNAMIC CHAIN CONFIGURATION SELECTION,” filed Jul. 10, 2017, assigned to the assignee hereof, and expressly incorporated herein.

### BACKGROUND

The following relates generally to wireless communication, and more specifically to dynamic chain configuration selection.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (i.e., Institute of Electrical and Electronics Engineers (IEEE) 802.11) network may include an access point (AP) that may communicate with one or more stations (STAs) or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via downlink and uplink. The downlink (or forward link) may refer to the communication link from the AP to the station, and the uplink (or reverse link) may refer to the communication link from the station to the AP.

A STA may communicate with an AP according to a number of different chain configuration modes, including modes that use multiple antennas or a single antenna. The power consumption and energy efficiency of each chain configuration mode may vary depending on the communication conditions. For example, a chain configuration mode that uses a single antenna may be more efficient than a chain configuration mode that uses multiple antennas (for receive, transmit, or both) in some circumstances, while a chain configuration mode that uses multiple antennas may be more efficient than a chain configuration mode that uses a single antenna in some circumstances. A STA that uses a constant chain configuration, for example by staying at all times in the same chain configuration mode during transmission and reception, may fail to effectively use more energy-efficient chain configuration modes, and thus use excess power and waste energy.

### SUMMARY

The described features generally relate to one or more improved systems, methods, and/or apparatuses for dynamic channel rank selection via channel analysis for wireless devices. More specifically, the described features generally relate to selectively operating a wireless device (e.g., a station (STA) or an access point (AP)) in different chain configuration modes based on energy efficiency and channel analysis. That is, a wireless device capable of supporting multiple chain configuration modes may dynamically select a chain configuration mode to use at a particular time via channel and energy efficiency analysis. A wireless device may monitor the traffic on a wireless channel using a first chain configuration mode. The wireless device may then determine an energy value associated with monitoring the traffic using a first chain configuration (e.g., using a single input and output, or multiple inputs and multiple outputs, or a single input and multiple outputs, or multiple inputs and a single output, etc.) in the first chain configuration mode, and further determine or infer an energy value associated with monitoring the traffic using a second chain configuration. The wireless device may perform a channel metric computation on the traffic (e.g., perform a QR decomposition of a channel matrix associated with the monitored traffic). The wireless device may then switch or select a chain configuration mode for operation based on a comparison between the determined energy values and the channel metric computation.

A method of wireless communication is described. The method may include monitoring, over a time duration, traffic on a wireless channel using a first chain configuration mode of the wireless device, determining a first energy value based at least in part on the traffic monitored using the first chain configuration mode, determining a second energy value for a second chain configuration mode of the wireless device based at least in part on the first energy value, comparing the first energy value to the second energy value, performing a channel metric computation on the traffic, and switching from operating the wireless device in the first chain configuration mode to operating the wireless device in the second chain configuration mode to communicate on the wireless channel based at least in part on the comparison and a result of the channel metric computation.

An apparatus for wireless communication is described. The apparatus may include means for monitoring, over a time duration, traffic on a wireless channel using a first chain configuration mode of the wireless device, means for determining a first energy value based at least in part on the traffic monitored using the first chain configuration mode, means for determining a second energy value for a second chain configuration mode of the wireless device based at least in part on the first energy value, means for comparing the first energy value to the second energy value, means for performing a channel metric computation on the traffic, and means for switching from operating the wireless device in the first chain configuration mode to operating the wireless device in the second chain configuration mode to communicate on the wireless channel based at least in part on the comparison and a result of the channel metric computation.

Another apparatus for wireless communication is described. The apparatus may include a processor, memory in electronic communication with the processor, and instructions stored in the memory. The instructions may be operable to cause the processor to monitor, over a time duration, traffic on a wireless channel using a first chain configuration mode of the wireless device, determine a first energy value based at least in part on the traffic monitored using the first chain configuration mode, determine a second energy value for a second chain configuration mode of the wireless device based at least in part on the first energy value, compare the first energy value to the second energy value, perform a channel metric computation on the traffic, and switch from operating the wireless device in the first chain configuration mode to operating the wireless device in the second chain configuration mode to communicate on the wireless channel based at least in part on the comparison and a result of the channel metric computation.

A non-transitory computer readable medium for wireless communication is described. The non-transitory computer-readable medium may include instructions operable to cause a processor to monitor, over a time duration, traffic on a wireless channel using a first chain configuration mode of the wireless device, determine a first energy value based at least in part on the traffic monitored using the first chain configuration mode, determine a second energy value for a second chain configuration mode of the wireless device based at least in part on the first energy value, compare the first energy value to the second energy value, perform a channel metric computation on the traffic, and switch from operating the wireless device in the first chain configuration mode to operating the wireless device in the second chain configuration mode to communicate on the wireless channel based at least in part on the comparison and a result of the channel metric computation.

Some examples of the method, apparatus, and non-transitory computer-readable medium described above may further include processes, features, means, or instructions for determining that the result of the channel metric computation may be less than a threshold, wherein switching from operating the wireless device in the first chain configuration mode to operating the wireless device in the second chain configuration mode may be based at least in part on the determination that the result of the channel metric computation may be less than the threshold.

In some examples of the method, apparatus, and non-transitory computer-readable medium described above, the second chain configuration mode comprises a multiple-input multiple-output (MIMO) operation mode.

In some examples of the method, apparatus, and non-transitory computer-readable medium described above, performing the channel metric computation comprises: computing eigenvalues of a channel matrix. Some examples of the method, apparatus, and non-transitory computer-readable medium described above may further include processes, features, means, or instructions for computing a ratio of a maximum eigenvalue to a minimum eigenvalue. Some examples of the method, apparatus, and non-transitory computer-readable medium described above may further include processes, features, means, or instructions for determining a channel condition number based at least in part on the ratio.

In some examples of the method, apparatus, and non-transitory computer-readable medium described above, performing the channel metric computation comprises: computing eigenvalues of a channel matrix. Some examples of the method, apparatus, and non-transitory computer-readable medium described above may further include processes, features, means, or instructions for computing a QR decomposition of the channel matrix for the wireless device. Some examples of the method, apparatus, and non-transitory computer-readable medium described above may further include processes, features, means, or instructions for identifying an R-matrix based at least in part on the QR decomposition. Some examples of the method, apparatus, and non-transitory computer-readable medium described above may further include processes, features, means, or instructions for determining a channel orthogonality based at least in part on elements of the identified R-matrix.

Some examples of the method, apparatus, and non-transitory computer-readable medium described above may further include processes, features, means, or instructions for sub-sampling one or more tones from a plurality of tones of the monitored traffic. Some examples of the method, apparatus, and non-transitory computer-readable medium described above may further include processes, features, means, or instructions for determining a wireless channel metric based at least in part on the sub-sampled one or more tones, wherein the wireless channel metric may be a channel condition number.

Some examples of the method, apparatus, and non-transitory computer-readable medium described above may further include processes, features, means, or instructions for determining a channel frequency coherence for the wireless channel. Some examples of the method, apparatus, and non-transitory computer-readable medium described above may further include processes, features, means, or instructions for selecting a set of the one or more tones to be sampled from the plurality of tones based at least in part on the determined channel coherence.

In some examples of the method, apparatus, and non-transitory computer-readable medium described above, determining the second energy value comprises: determining, for the first chain configuration mode, a first receive duration for the monitored traffic, the first energy value being determined based at least in part on the first receive duration. Some examples of the method, apparatus, and non-transitory computer-readable medium described above may further include processes, features, means, or instructions for determining, for the second chain configuration mode, a second receive duration for the monitored traffic based at least in part on the first receive duration. Some examples of the method, apparatus, and non-transitory computer-readable medium described above may further include processes, features, means, or instructions for determining the second energy value for the monitored traffic based at least in part on the second receive duration.

In some examples of the method, apparatus, and non-transitory computer-readable medium described above, determining the second receive duration for the monitored traffic based at least in part on the first receive duration comprises: determining a factor to be applied to the first receive duration based at least in part on one or both of the first chain configuration mode and the second chain configuration mode. Some examples of the method, apparatus, and non-transitory computer-readable medium described above may further include processes, features, means, or instructions for applying the determined factor to the first receive duration to generate the second receive duration.

In some examples of the method, apparatus, and non-transitory computer-readable medium described above, determining, for the first chain configuration mode, the first energy value for the monitored traffic comprises: determining, for the first chain configuration mode, one or more of a listen power, a listen duration, a receive power, a receive duration, a sleep power, and a sleep duration for the monitored traffic during the time duration. Some examples of the method, apparatus, and non-transitory computer-readable medium described above may further include processes, features, means, or instructions for determining the first energy value for the monitored traffic based at least in part on one or more of the listen duration, the listen power, the receive duration, the receive power, the sleep duration, and the sleep power.

Some examples of the method, apparatus, and non-transitory computer-readable medium described above may further include processes, features, means, or instructions for determining a chain correlation value for a plurality of receive chains of the wireless device, wherein switching from operating the wireless device in the first chain configuration mode to operating the wireless device in the second chain configuration mode may be further based at least in part on the determined chain correlation value.

Some examples of the method, apparatus, and non-transitory computer-readable medium described above may further include processes, features, means, or instructions for determining that the chain correlation value exceeds a threshold, wherein switching from operating the wireless device in the first chain configuration mode to operating the wireless device in the second chain configuration mode may be further based at least in part on the determination that the chain correlation value exceeds the threshold.

In some examples of the method, apparatus, and non-transitory computer-readable medium described above, the second chain configuration mode comprises a single-input single-output (SISO) operation mode.

Some examples of the method, apparatus, and non-transitory computer-readable medium described above may further include processes, features, means, or instructions for determining a chain power imbalance value for a plurality of receive chains of the wireless device, wherein switching from operating the wireless device in the first chain configuration mode to operating the wireless device in the second chain configuration mode may be further based at least in part on the determined chain power imbalance value.

Some examples of the method, apparatus, and non-transitory computer-readable medium described above may further include processes, features, means, or instructions for determining that the chain power imbalance value exceeds a threshold, wherein switching from operating the wireless device in the first chain configuration mode to operating the wireless device in the second chain configuration mode may be further based at least in part on the determination that the chain power imbalance value exceeds the threshold.

In some examples of the method, apparatus, and non-transitory computer-readable medium described above, the second chain configuration mode comprises a SISO operation mode.

Some examples of the method, apparatus, and non-transitory computer-readable medium described above may further include processes, features, means, or instructions for determining a signal-to-noise ratio (SNR) for the monitored traffic, wherein switching from operating the wireless device in the first chain configuration mode to operating the wireless device in the second chain configuration mode may be further based at least in part on the determined SNR.

Some examples of the method, apparatus, and non-transitory computer-readable medium described above may further include processes, features, means, or instructions for determining that the SNR exceeds a threshold, wherein switching from operating the wireless device in the first chain configuration mode to operating the wireless device in the second chain configuration mode may be further based at least in part on the determination that the SNR exceeds the threshold.

In some examples of the method, apparatus, and non-transitory computer-readable medium described above, the second chain configuration mode comprises a SISO operation mode.

Some examples of the method, apparatus, and non-transitory computer-readable medium described above may further include processes, features, means, or instructions for determining that the SNR may be less than a threshold, wherein switching from operating the wireless device in the first chain configuration mode to operating the wireless device in the second chain configuration mode may be further based at least in part on the determination that the SNR may be less than the threshold.

In some examples of the method, apparatus, and non-transitory computer-readable medium described above, the second chain configuration mode comprises a single-input multiple-output (SIMO) operation mode.

In some examples of the method, apparatus, and non-transitory computer-readable medium described above, the first chain configuration mode may be a MIMO operation mode. In some examples of the method, apparatus, and non-transitory computer-readable medium described above, the second chain configuration mode may be a SISO operation mode or a SIMO operation mode.

In some examples of the method, apparatus, and non-transitory computer-readable medium described above, the first chain configuration mode may be a SISO operation mode or a SIMO operation mode. In some examples of the method, apparatus, and non-transitory computer-readable medium described above, the second chain configuration mode may be a MIMO operation mode.

A method of wireless communication is described. The method may include monitoring, over a time duration, traffic on a wireless channel using a MIMO operation mode, determining a first energy value based at least in part on the traffic monitored using the MIMO operation mode, determining a second energy value for a SISO operation mode for the wireless device based at least in part on the first energy value, performing a channel metric computation on the traffic if the first energy value is less than the second energy value, operating in the MIMO operation mode if a result of the channel metric computation indicates that a channel matrix associated with the monitored traffic has a correlation value less than a first threshold, determining, if the first energy value is greater than the second energy value, or if the result of the channel metric computation indicates that the channel matrix has the correlation value greater than the first threshold, a chain correlation value for a plurality of receive chains of the wireless device, switching from operating the wireless device in the MIMO operation mode to operating the wireless device in the SISO operation mode if the chain correlation value is greater than a second threshold, determining, if the chain correlation value is less than the second threshold, a chain power imbalance value for a plurality of receive chains of the wireless device, switching from operating the wireless device in the MIMO operation mode to operating the wireless device in the SISO operation mode if the chain power imbalance value is greater than a third threshold, determining, if the chain power imbalance value is less than the third threshold, a SNR for the monitored traffic, switching from operating the wireless device in the MIMO operation mode to operating the wireless device in the SISO operation mode if the SNR is greater than a fourth threshold, and switching from operating the wireless device in the MIMO operation mode to operating the wireless device in a SIMO operation mode if the SNR is less than the fourth threshold.

An apparatus for wireless communication is described. The apparatus may include means for monitoring, over a time duration, traffic on a wireless channel using a MIMO operation mode, means for determining a first energy value based at least in part on the traffic monitored using the MIMO operation mode, means for determining a second energy value for a SISO operation mode for the wireless device based at least in part on the first energy value, means for performing a channel metric computation on the traffic if the first energy value is less than the second energy value, means for operating in the MIMO operation mode if a result of the channel metric computation indicates that a channel matrix associated with the monitored traffic has a correlation value less than a first threshold, means for determining, if the first energy value is greater than the second energy value, or if the result of the channel metric computation indicates that the channel matrix has the correlation value greater than the first threshold, a chain correlation value for a plurality of receive chains of the wireless device, means for switching from operating the wireless device in the MIMO operation mode to operating the wireless device in the SISO operation mode if the chain correlation value is greater than a second threshold, means for determining, if the chain correlation value is less than the second threshold, a chain power imbalance value for a plurality of receive chains of the wireless device, means for switching from operating the wireless device in the MIMO operation mode to operating the wireless device in the SISO operation mode if the chain power imbalance value is greater than a third threshold, means for determining, if the chain power imbalance value is less than the third threshold, a SNR for the monitored traffic, means for switching from operating the wireless device in the MIMO operation mode to operating the wireless device in the SISO operation mode if the SNR is greater than a fourth threshold, and means for switching from operating the wireless device in the MIMO operation mode to operating the wireless device in a single-input multiple-output (SIMO) operation mode if the SNR is less than the fourth threshold.

Another apparatus for wireless communication is described. The apparatus may include a processor, memory in electronic communication with the processor, and instructions stored in the memory. The instructions may be operable to cause the processor to monitor, over a time duration, traffic on a wireless channel using a MIMO operation mode, determine a first energy value based at least in part on the traffic monitored using the MIMO operation mode, determine a second energy value for a SISO operation mode for the wireless device based at least in part on the first energy value, perform a channel metric computation on the traffic if the first energy value is less than the second energy value, operate in the MIMO operation mode if a result of the channel metric computation indicates that a channel matrix associated with the monitored traffic has a correlation value less than a first threshold, determine, if the first energy value is greater than the second energy value, or if the result of the channel metric computation indicates that the channel matrix has the correlation value greater than the first threshold, a chain correlation value for a plurality of receive chains of the wireless device, switch from operating the wireless device in the MIMO operation mode to operating the wireless device in the SISO operation mode if the chain correlation value is greater than a second threshold, determine, if the chain correlation value is less than the second threshold, a chain power imbalance value for a plurality of receive chains of the wireless device, switch from operating the wireless device in the MIMO operation mode to operating the wireless device in the SISO operation mode if the chain power imbalance value is greater than a third threshold, determine, if the chain power imbalance value is less than the third threshold, a SNR for the monitored traffic, switch from operating the wireless device in the MIMO operation mode to operating the wireless device in the SISO operation mode if the SNR is greater than a fourth threshold, and switch from operating the wireless device in the MIMO operation mode to operating the wireless device in a SIMO operation mode if the SNR is less than the fourth threshold.

A non-transitory computer readable medium for wireless communication is described. The non-transitory computer-readable medium may include instructions operable to cause a processor to monitor, over a time duration, traffic on a wireless channel using a MIMO operation mode, determine a first energy value based at least in part on the traffic monitored using the MIMO operation mode, determine a second energy value for a SISO operation mode for the wireless device based at least in part on the first energy value, perform a channel metric computation on the traffic if the first energy value is less than the second energy value, operate in the MIMO operation mode if a result of the channel metric computation indicates that a channel matrix associated with the monitored traffic has a correlation value less than a first threshold, determine, if the first energy value is greater than the second energy value, or if the result of the channel metric computation indicates that the channel matrix has the correlation value greater than the first threshold, a chain correlation value for a plurality of receive chains of the wireless device, switch from operating the wireless device in the MIMO operation mode to operating the wireless device in the SISO operation mode if the chain correlation value is greater than a second threshold, determine, if the chain correlation value is less than the second threshold, a chain power imbalance value for a plurality of receive chains of the wireless device, switch from operating the wireless device in the MIMO operation mode to operating the wireless device in the SISO operation mode if the chain power imbalance value is greater than a third threshold, determine, if the chain power imbalance value is less than the third threshold, a SNR for the monitored traffic, switch from operating the wireless device in the MIMO operation mode to operating the wireless device in the SISO operation mode if the SNR is greater than a fourth threshold, and switch from operating the wireless device in the MIMO operation mode to operating the wireless device in a SIMO operation mode if the SNR is less than the fourth threshold.

### BRIEF DESCRIPTION OF THE DRAWINGS

FIG. 1 illustrates an example of a system for wireless communication that supports dynamic chain configuration selection in accordance with aspects of the present disclosure.

FIG. 2 illustrates an example of a wireless communications system that supports dynamic chain configuration selection in accordance with aspects of the present disclosure.

FIG. 3 illustrates an example of a process flow that supports dynamic chain configuration selection in accordance with aspects of the present disclosure.

FIG. 4 illustrates an example of dynamic chain configuration selection in accordance with aspects of the present disclosure.

FIG. 5 illustrates an example of a timing diagram that supports dynamic chain configuration selection in accordance with aspects of the present disclosure.

FIG. 6 illustrates an example of a timing diagram that supports dynamic chain configuration selection in accordance with aspects of the present disclosure.

FIGS. 7 through 9 show block diagrams of a device that supports dynamic chain configuration selection in accordance with aspects of the present disclosure.

FIG. 10 illustrates a block diagram of a system including a STA that supports dynamic chain configuration selection in accordance with aspects of the present disclosure.

FIGS. 11 through 12B illustrate methods for dynamic chain configuration selection in accordance with aspects of the present disclosure.

### DETAILED DESCRIPTION

The described features generally relate to improved channel rank selection (e.g., through chain configuration selection) for a wireless device, such as a station (STA) or an access point (AP), of a wireless network by switching between chain configuration modes in which the wireless device is operating. The switching may be based on communication conditions, for example as determined from a channel analysis. Though generally described herein with reference to a STA, the described features relating to improved chain configuration selection may be implemented by different wireless devices, for example a STA or an AP or another wireless device.

A STA may detect certain communication conditions on a wireless channel, and switch its chain configuration mode in response to these conditions. Power consumption and energy use by the chain configuration modes may vary with communication conditions. In an example featuring a wireless device configured to operate using two chain configuration modes, one of the modes (e.g., a multi chain configuration mode) may be more energy efficient when the STA is operating in certain communication conditions. For example, a multi chain configuration mode may be more efficient in high throughput or high packet rate scenarios, scenarios associated with low channel correlation, etc. Another mode (e.g., a single chain configuration mode) may be more energy efficient in other communication conditions. For example, the single chain configuration mode may be more efficient in low throughput or low packet rate scenarios, scenarios associated with high channel correlation, etc.

In some cases, a STA may support a chain configuration mode that uses multiple chains (e.g., for multiple-input multiple-output (MIMO) operation, or single-input multiple-output (SIMO), or multiple-input single-output (MISO), etc.), which may be referred to as a multi-chain mode, to transmit or receive traffic on a channel. The STA may also support a chain configuration mode that uses a single chain (e.g., single-input single-output (SISO) operation), which may be referred to as a single-chain mode, for such communications. During receive operations, the multi-chain mode may receive packets faster and consume more power per unit time than the single-chain mode. The multi-chain mode and the single-chain mode may be energy efficient in different communication scenarios. For example, a STA may wait a period of time (e.g., an inactivity interval or listening interval) after the last packet of a received transmission before powering down, during which the STA may be listening for transmissions. During such time, the STA may be available to receive a packet or other transmissions. If a packet it not received during the inactivity interval, the STA may go into a low power mode after the inactivity interval.

In some cases, the energy efficiency of a chain configuration mode may vary with communication conditions, such as packet rate. For example, packets in a downlink transmission may be sent to a STA in rapid succession (e.g., at a high packet rate). In such cases, the STA may receive the transmission quickly by using the multi-chain mode. Due to the high packet rate, the inactivity intervals may be shorter in the multi-chain mode than in the single-chain mode, which means the STA can more quickly enter a low power mode, thereby saving energy. If instead of the multi-chain mode the STA uses a single-chain mode to receive the packets, completion of the transmission may take longer, which may delay entrance into the low power mode and cost the STA energy. Thus, a multi-chain configuration mode may be more energy efficient than a single-chain mode for high-throughput, or high packet rate, communications.

In other cases, packets in a downlink transmission may be sent to the STA in a slower succession than the quick succession described above. In such cases, the STA may spend similar amounts of time in low power mode regardless of the chain configuration used. But the STA may consume less power per unit time to receive the packets by using the single-chain mode instead of the multi-chain mode. Thus, a single-chain configuration mode may be more energy efficient than a multi-chain configuration for low-throughput, or low packet rate, communications.

Additionally, the energy efficiency of a chain configuration mode may vary with characteristics of the channel, such as channel correlation. For example, according to techniques described herein, in addition to channel throughput (e.g., packet rate or other communication conditions), a chain configuration (e.g., configuration mode) may be selected based on characteristics of the channel. Such techniques may be referred to as dynamic chain management. For example, in some scenarios (e.g., scenarios associated with strong channel correlation), the same throughput and traffic pattern may be realized in a more energy efficient manner by operating in a non-MIMO mode (e.g., SISO, or SIMO). Thus, where a STA operates in a preconfigured or static chain configuration mode, the chain configuration mode may be energy inefficient and waste power in some circumstances in which the STA operates. As such, increased energy efficiency may be realized according to dynamic chain configuration selection techniques described herein.

The following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

Aspects of the disclosure are initially described in the context of a wireless communications system. Example process flows and transmission timelines are then discussed. Aspects of the disclosure are further illustrated by and described with reference to apparatus diagrams, system diagrams, and flowcharts that relate to dynamic chain configuration selection

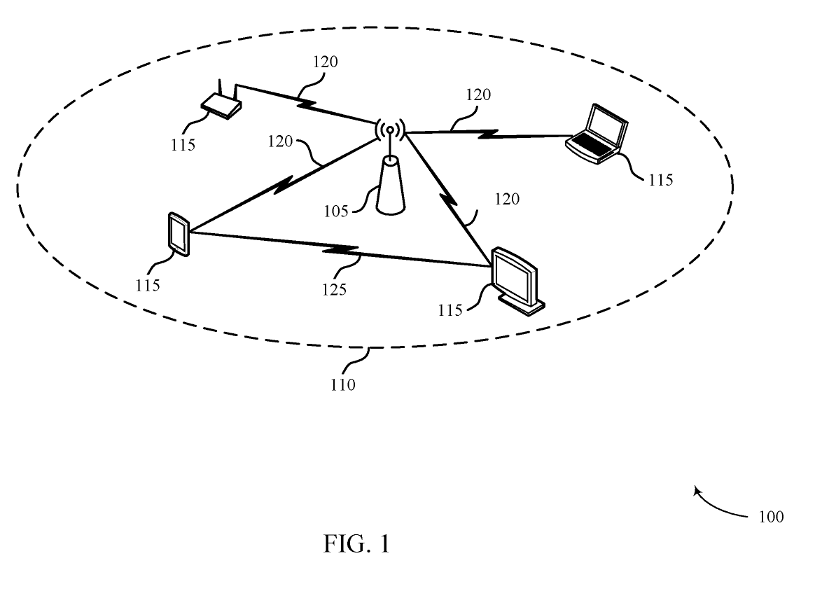

FIG. 1 illustrates a wireless communications system 100 configured in accordance with various aspects of the present disclosure. The wireless communications system 100 may be an example of a wireless local area network (WLAN) (also known as a Wi-Fi network, such as 802.11ax) and may include an access point (AP) 105 and multiple associated stations (STAs) 115. Devices in wireless communications system 100 may communicate over unlicensed spectrum, which may be a portion of spectrum that includes frequency bands traditionally used by Wi-Fi technology, such as the 5 GHz band, the 2.4 GHz band, the 60 GHz band, the 3.6 GHz band, and/or the 900 MHz band. The STAs 115 may represent devices such as mobile stations, wireless communication terminals, phones, personal digital assistant (PDAs), other handheld devices, netbooks, notebook computers, tablet computers, laptops, display devices (e.g., TVs, computer monitors, etc.), printers, etc. The AP 105 and the associated STAs 115 may represent a basic service set (BSS) or an extended service set (ESS). The various STAs 115 in the network are able to communicate with one another through the AP 105. Also shown is a coverage area 110 of the AP 105, which may represent a basic service area (BSA) of the wireless communications system 100. An extended network station associated with the wireless communications system 100 may be connected to a wired or wireless distribution system that may allow multiple APs 105 to be connected in an ESS. The AP 105 and STAs 115 may support multiple chain configurations for communication. The energy efficiency of the chains configurations may vary based on the communication conditions. According to the techniques described herein, a STA 115 may autonomously adapt to various communication conditions by dynamically selecting chain configuration modes to operate in given the communication conditions.

In some cases, a STA 115 may be located in the intersection of more than one coverage area 110 and may associate with more than one AP 105. A single AP 105 and an associated set of STAs 115 may be referred to as a BSS. An ESS is a set of connected BSSs. A distribution system may be used to connect APs 105 in an ESS. In some cases, the coverage area 110 of an AP 105 may be divided into sectors. The wireless communications system 100 may include APs 105 of different types (e.g., metropolitan area, home network, etc.), with varying and overlapping coverage areas 110. Two STAs 115 may also communicate directly via a direct wireless link 125 regardless of whether both STAs 115 are in the same coverage area 110. Examples of direct wireless links 125 may include Wi-Fi Direct connections, Wi-Fi Tunneled Direct Link Setup (TDLS) links, and other group connections. STAs 115 and APs 105 may communicate according to the WLAN radio and baseband protocol for physical (PHY) and medium access control (MAC) layers from IEEE 802.11 and versions including, but not limited to, 802.11b, 802.11g, 802.11a, 802.11n, 802.11ac, 802.11ad, 802.11ah, 802.11ax, 802.11az, 802.11ba, etc. In other implementations, peer-to-peer connections or ad hoc networks may be implemented within wireless communications system 100.

In some cases, a STA 115 (or an AP 105) may be detectable by a central AP 105, but not by other STAs 115 in the coverage area 110 of the central AP 105. For example, one STA 115 may be at one end of the coverage area 110 of the central AP 105 while another STA 115 may be at the other end. Thus, both STAs 115 may communicate with the AP 105, but may not receive the transmissions of the other. This may result in colliding transmissions for the two STAs 115 in a contention-based environment (e.g., CSMA/CA) because the STAs 115 may not refrain from transmitting on top of each other. A STA 115 whose transmissions are not identifiable, but that is within the same coverage area 110 may be known as a hidden node. CSMA/CA may be supplemented by the exchange of an RTS packet transmitted by a sending STA 115 (or AP 105) and a CTS packet transmitted by the receiving STA 115 (or AP 105). This may alert other devices within range of the sender and receiver not to transmit for the duration of the primary transmission. Thus, RTS/CTS may help mitigate a hidden node problem.

An AP 105 may communicate with a STA 115 via uplink and downlink. Uplink transmissions may refer to transmissions from the STA 115 to the AP 105 and downlink transmissions may refer to transmissions from the AP 105 to the STA 115. A number of communication techniques may be used for downlink (DL) and uplink (UL) transmissions. For example, a wireless device (e.g., an AP 105) may implement beamforming in which the energy of a transmission is focused in a particular direction (e.g., towards a STA 115, or a set of STAs 115). In some cases, single-input-single-output (SISO) techniques may be used for communications between an AP 105 and STA 115 in which both the AP 105 and the STA 115 use a single antenna. In other cases, multiple-input-multiple-output (MIMO) techniques may be used for when the AP 105 and/or STA 115 involved in a communication include multiple antennas. Other chain configurations may include single-input-multiple-output (SIMO) configurations and multiple-input-single-output (MISO) configurations. SIMO techniques may refer to a single transmitting antenna and two or more receiving antennas. Such techniques may improve reception diversity as a receiver system may receive signals from a number of independent sources to combat fading effects experienced by a transmitted signal. MISO techniques may refer to two or more transmitting antennas and a single receiving antenna. Such techniques may be associated with improved transmit diversity gain, as a stream of data may be transmitted redundantly via the two or more transmit antennas. Further, such techniques may enable redundancy coding and processing at the transmitter, which may reduce processing requirements at a receiver. Efficient use of MIMO, MISO, SIMO, and SISO chain configurations may be dependent on particular communication conditions (e.g., channel conditions, traffic conditions, etc.), as discussed further below.

In some cases, uplink and/or downlink multi-user MIMO (MU-MIMO) may be used. For example, uplink/downlink single-user MIMO (SU-MIMO) may be used in which multiple streams of data are simultaneously communicated (e.g., from an AP 105 to a STA 115) using multiple antennas and beamforming technology. In multi-user MIMO (MU-MIMO), for example downlink MU-MIMO, an AP 105 may simultaneously send multiple streams to multiple STAs 115 by taking advantage of spatial diversity in transmission resources and multiple antennas.

Different chain configurations may be used to implement SISO, MIMO, MISO, and/or SIMO techniques. For example, a chain configuration that includes one antenna may be used for SISO communications and a chain configuration that uses multiple antennas may be used for MIMO techniques. The power consumption of a chain configuration for a wireless device may be related to the number of chains in use by the wireless device in a particular chain configuration mode, for example because more chains may use more power. Thus, a SISO chain configuration may use less power per unit time than a MIMO chain configuration. The rate at which data can be received may also be related to the number of chains (e.g., more chains may receive data faster). Thus, a MIMO chain configuration may complete data reception faster than a SISO chain configuration.

In some cases, a STA 115 may wait a period of time after the last packet of a received transmission before powering down. If another packet is received during this period of time, the STA 115 may be available to receive the packet. If a packet is not received during this period of time, the STA 115 may go into a low power mode. When packets in a downlink transmission are sent to a STA 115 in quick succession, the STA 115 may use a MIMO chain configuration. The use of a MIMO chain configuration may enable the STA 115 to receive the entire transmission quickly and enter a low power mode, which may compensate for the extra power used to perform MIMO techniques. When packets in a downlink transmission are sent to the STA 115 in slow succession, the STA 115 may use a SISO chain configuration. The use of the SISO chain configuration may use less power than a MIMO chain configuration per unit time, which may compensate for a delayed low power mode that is due to the slower receive capabilities of the SISO chain configuration. Thus, according to the techniques discussed herein, a STA 115 may dynamically switch between different chain configurations based on communication conditions such as throughput and packet rate.

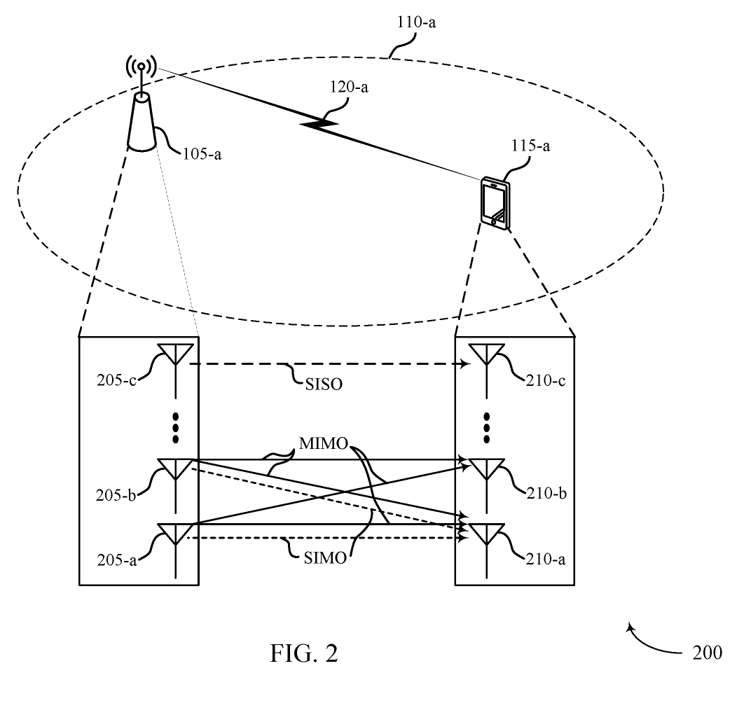

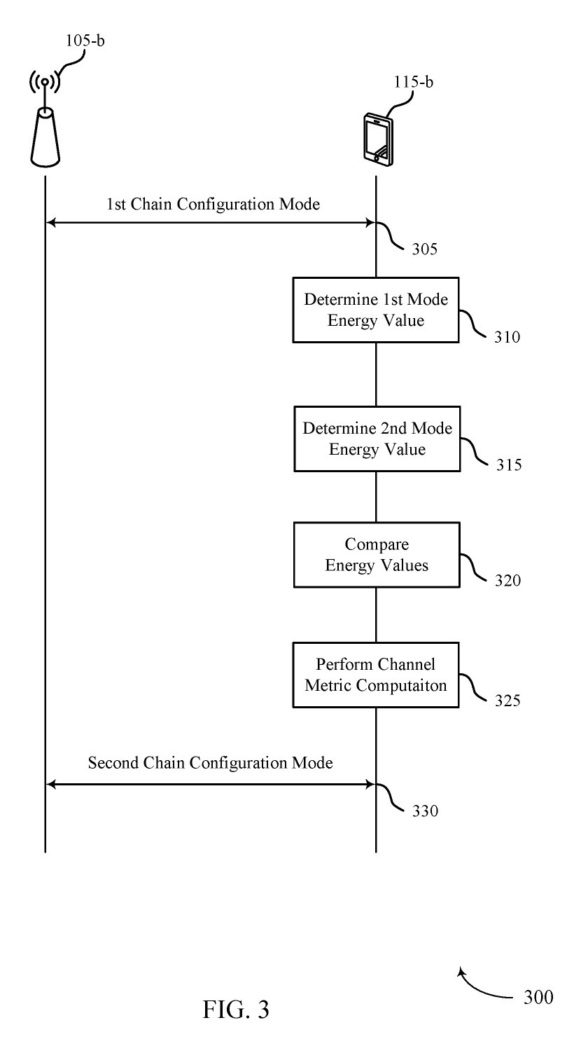

FIG. 2 illustrates an example of a wireless communications system 200 that supports dynamic chain configuration selection in accordance with various aspects of the present disclosure. In some examples, wireless communications system 200 may implement aspects of wireless communications system 100. Wireless communications system 200 includes an AP 105-a and STA 115-a, which may be examples of the corresponding devices described with reference to FIG. 1. AP 105-a may communicate with wireless devices inside coverage area 110-a; for example, AP 105-a may communicate with STA 115-a over a wireless channel via communication link 120-a. AP 105-a and STA 115-a may be capable of communicating using a variety of chain configuration modes. According to the techniques described herein, STA 115-a may dynamically and autonomously update its chain configuration mode based on communication conditions determined by STA 115-a.

AP 105-a may include multiple antennas 205 (e.g., N antennas). For example, AP 105-a may include antenna 205-a, antenna 205-b, and antenna 205-c. STA 115-a may also include multiple antennas 210. For example, AP 105-a may include antennas 210-a, 210-b, through 210-c. Although shown with three antennas, AP 105-a may include any number of antennas, and STA 115-a may also include any number of antennas, which may the same number or a different number of antennas as AP 105-a. Each antenna, which may form a part of one or more antenna arrays, may be coupled with processing circuitry. The antenna with processing circuitry may be referred to herein as a chain. In some cases, an antenna may be associated with multiple chains. A single chain may also be associated with multiple antennas. Each chain may receive a respective spatial stream of data. Thus, the signal strength at a chain may be specific to that chain (e.g., each chain may be associated with a respective signal strength). Accordingly, in some cases, a difference in signal strength may occur between chains in a chain configuration. A wireless device may enable (e.g., turn on) or disable (e.g., turn off) different chains to implement various chain configuration modes. A wireless device using a particular chain configuration mode for communications may be said to be operating in, or according to, that particular chain configuration mode.

In some cases, STA 115-a may operate in a chain configuration mode that uses a single chain and antenna. For example, STA 115-a may employ single-input-single-output (SISO) techniques in which STA 115-a uses a single antenna (e.g., antenna 210-c) and chain to receive communications from AP 105-a, which also uses a single antenna (e.g., antenna 205-c) and chain. Such a chain configuration may be referred to herein as a 1×1 chain configuration or 1×1 mode. In another example, STA 115-a may operate in a chain configuration mode that uses a single chain to receive while AP 105-a operates in a chain configuration mode that uses multiple chains to transmit (e.g., a STA 115-a may partake in multiple-input-single-output (MISO) communications, which may also be referred to as m×1 communications). In general, an m×n chain configuration (or configuration mode or mode) may describe the number of chains used by the respective devices involved in the communication. For example, m chains at a transmitting device and n chains at a receiving device may be used for communications associated with an m×n chain configuration.

In some examples, STA 115-a may operate in a chain configuration mode that uses multiple antennas. For example, STA 115-a may employ MIMO techniques in which STA 115-a uses multiple antennas (e.g., antenna 210-a and antenna 210-b) to receive communications from AP 105-a, which also uses multiple antennas (e.g., antenna 205-a and 205-b) to transmit. Thus, a chain configuration that uses multiple chains may be used for MIMO techniques. When two chains are used per wireless device, the chain configuration may be referred to as a 2×2 chain configuration. MIMO may use a technique called spatial division multiplexing that takes advantage of the multiple transmit and receive chains to send multiple streams of data simultaneously on the same wireless channel, thereby increasing data rate and overall throughput. In another example, STA 115-a may operate in a chain configuration mode that uses multiple chains while AP 105-a may operate in a chain configuration mode that uses a single chain (e.g., a STA 115-a may partake in single-input-multiple-output (SIMO) communications, which may also be referred to as 1×n communications).

In some cases, the energy efficiency of a chain configuration mode may vary with communication conditions, such as packet rate. Each chain configuration mode may have energy implications that differ from other chain configuration modes. For example, when actively communicating (e.g., transmitting and receiving), a chain configuration mode that uses multiple chains may consume more power per unit of time compared to a chain configuration mode that uses a single chain. However, a chain configuration mode that uses multiple chains may receive more data per unit of time compared to a single chain counterpart, which may allow the STA 115 to enter low power mode sooner compared to a single chain, and therefore remain in a lower power mode longer before the next high power mode.

For example, when packet rate is high, the use of multiple chains at STA-a may be more energy efficient than the use of a single chain because the higher power consumption of the multiple chains is compensated for by spending more time in low power mode compared to the single chain. For instance, when AP 105-a has data for STA 115-a and sends packets in quick succession, STA 115-a may use multiple chains to receive data from a transmitting device more quickly and enter a low power mode (e.g., power collapse) sooner than would otherwise be possible using a single chain. Thus, when a packet rate is higher than a certain threshold, a STA 115 using multiple chains that may consume more power per unit of time compared to a single chain, but spend more time in low power mode, which may result in improved energy efficiency.

For example, a chain configuration mode that uses multiple chains may enable communication via multiple (e.g., two for a 2×2 MIMO configuration) data streams, improving system throughput. However, the increased power consumption (e.g., due to operation of additional receive chains) may not correspond directly (e.g., one-to-one) to the magnitude of the additional data streams, as some circuitry (e.g., hardware blocks) may be shared between the receive chains, thus resulting in less energy consumed per amount of data received. That is, the power cost for operation of a multi chain configuration mode may be less than the power cost for operation of a single chain multiplied by the total number of chains in the multi chain configuration mode, while the data rate may increase by a factor corresponding to the number of additional chains.

Alternatively, when the packet rate is lower than a certain threshold, a STA 115 may improve energy efficiency by using a chain configuration with a single chain. Again, this may be the case due to the tradeoff between power consumption per unit time during active communication and the amount of time the STA 115 is allowed to be in a low power state. A STA 115 that receives packets at a low rate may spend less energy receiving the packets using a single chain opposed to multiple chains, and may spend a comparable amount of time in low power mode, resulting in greater energy efficiency.

Additionally, the energy efficiency of a chain configuration mode may vary with characteristics of the channel, such as channel correlation (e.g., the spread or distribution of channel eigenvalues), chain correlation for receive chains, chain power imbalance, or a signal to noise ratio of a chain configuration mode.

FIG. 3 illustrates an example of a process flow 300 that supports dynamic chain configuration selection in accordance with various aspects of the present disclosure. In some examples, process flow 300 may implement aspects of wireless communications system 100. Process flow 300 may represent aspects of techniques performed by an AP 105-b and STA 115-b, which may represent the corresponding devices as described with reference to FIGS. 1-2. STA 115-b may include multiple antennas and antenna chains. STA 115-b may autonomously select, in some examples without a command from AP 105-a to do so, a chain configuration mode based on dynamic channel rank selection techniques described herein.

At 305, STA 115-b may participate in communications with AP 105-b using a first chain configuration mode. For example, STA 115-b may transmit packets to AP 105-b and/or receive packets from AP 105-b over a wireless channel. The first chain configuration mode may use a single chain or multiple chains, for example 1×1 modes or 2×2 modes, etc. STA 115-b may monitor traffic on a wireless channel using the first chain configuration mode for a given time duration.

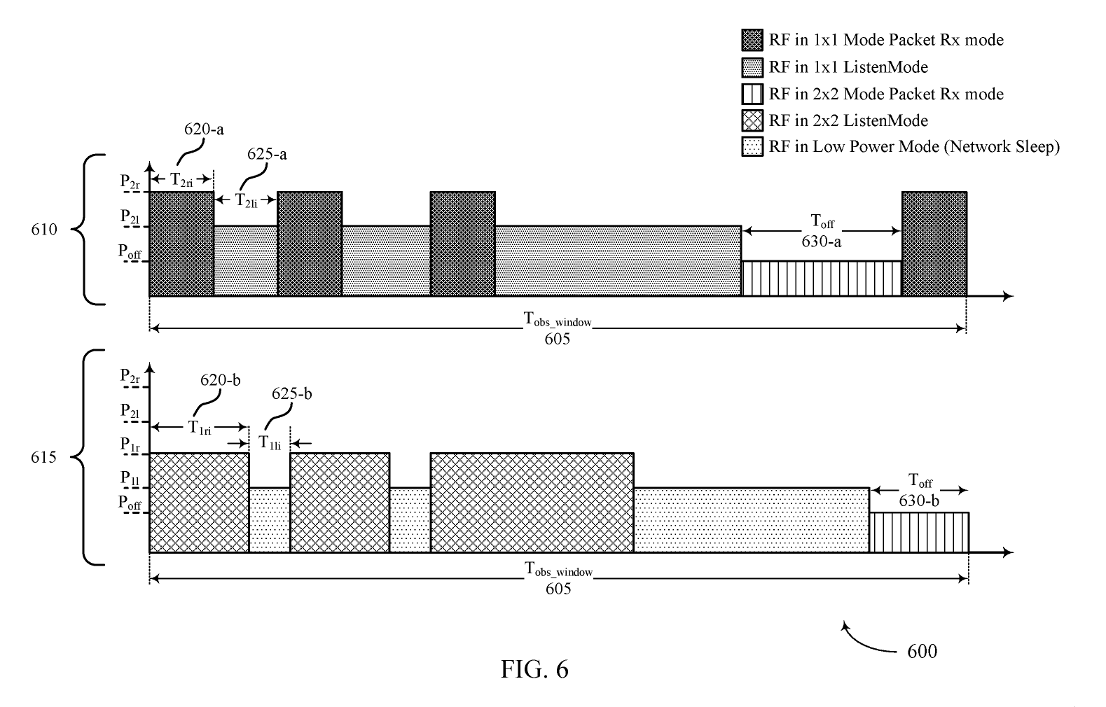

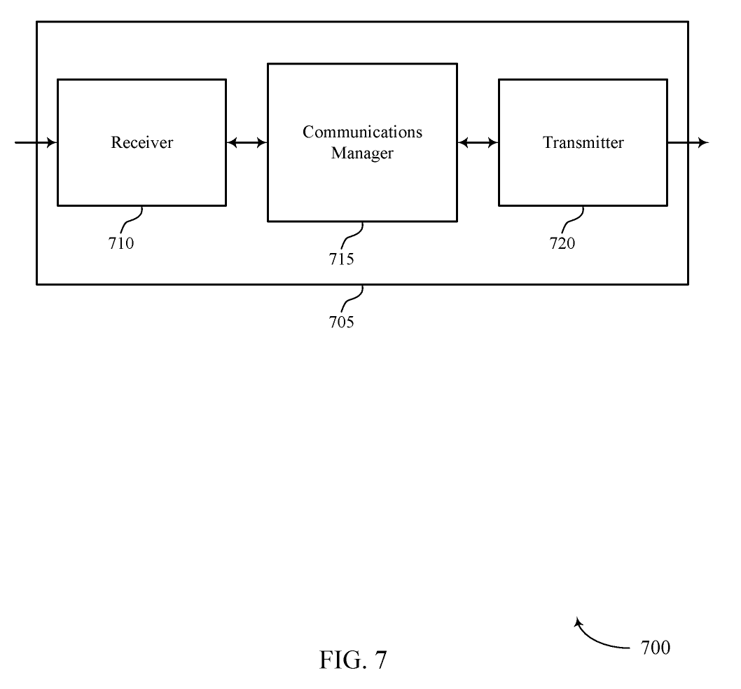

At 310, STA 115-b may determine a first energy value based on the traffic monitored using the first chain configuration mode (e.g., at 305). At 315, STA 115-b may determine a second energy value (e.g., inferred for an associated second chain configuration mode) based on the traffic monitored using the first chain configuration mode (e.g., at 305). At 320, STA 115-b may compare the first energy value to the second energy value, such that an energy efficiency determination may be made. The first and second energy values, as well as the energy efficiency determination, may be determined according to techniques described in more detail below (e.g., with reference to FIG. 6).

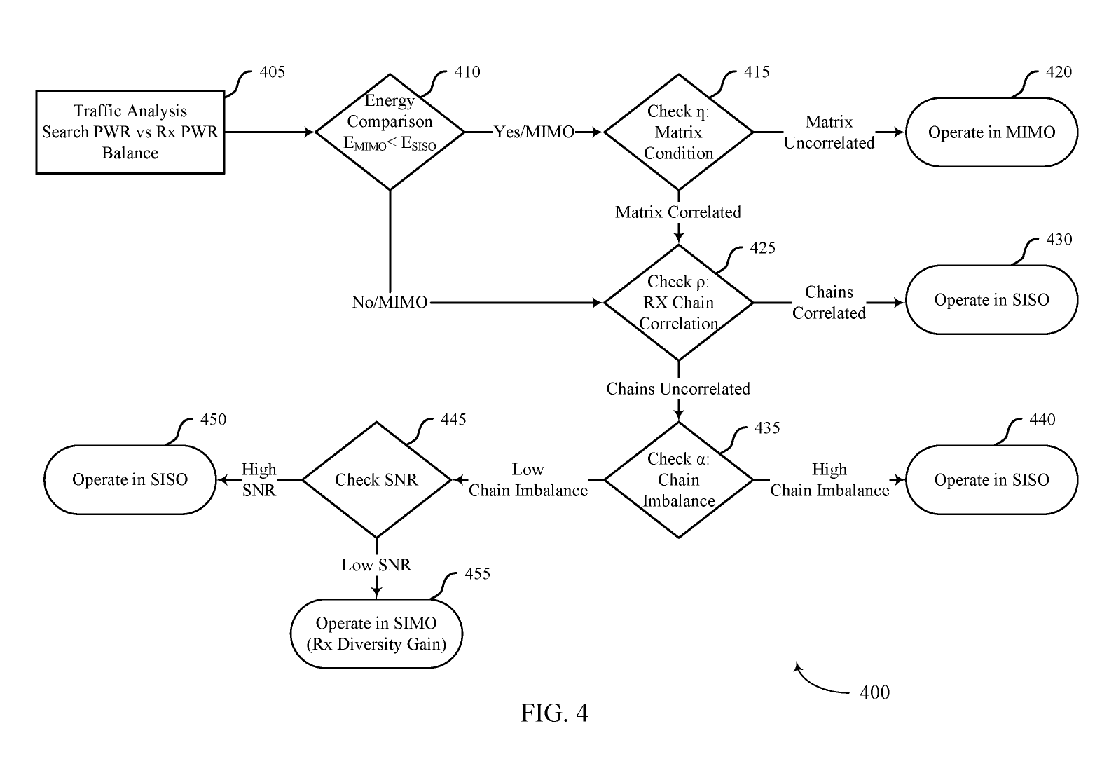

At 325, STA 115-b may perform a channel metric computation on the traffic (e.g., perform channel analysis). In some cases, the operation may be performed according to techniques described in more detail below (e.g., with reference to FIG. 4, and in particular with reference to step 415). As an example, the STA 115-b may determine that the result of the channel metric computation is less than a threshold, resulting in a determination to proceed to 330.

At 330, STA 115-b may switch from operating in the first chain configuration mode to operating in the second chain configuration mode to communicate on the wireless channel based at least in part on the comparison of 320 and a result of the channel metric computation of 325. That is, STA 115-b may communicate with AP 105-b over the wireless channel using the second chain configuration mode. The second chain configuration mode may use multiple chains or a single chain, for example 2×2 modes or 1×1 modes, etc., and be different from the first chain configuration mode. For example the first chain configuration mode may be a 1×1 mode, while the second chain configuration mode may be a 2×2 mode, or vice versa. In some cases, STA 115-b may inform AP 105-b of the new chain configuration mode. For instance, STA 115-b may transmit an explicit indication of the second chain configuration mode (e.g., in a spatial multiplexing power save (SMPS) action frame. Alternatively, STA 115-b may transmit an implicit indication of the second chain configuration mode by embedding the indication in a data frame (e.g., by using receiver operating mode indicator (ROMI) triggers). In other cases, STA 115-b may not inform AP 105-b of the second chain configuration.

FIG. 4 illustrates an example of a flow diagram 400 that supports dynamic chain configuration selection in accordance with various aspects of the present disclosure. In some examples, flow diagram 400 may implement aspects of wireless communications system 100. Flow diagram 400 may represent aspects of techniques performed by a STA 115 as described with reference to FIGS. 1-3. STA 115-b may be capable of operating in various chain configuration modes. The STA 115-b may dynamically select a chain configuration mode (e.g., channel rank selection) based on determinations and conditions discussed below. The STA 115-b may be capable of supporting a maximum number of N chains. Thus, the full rank mode, or highest chain configuration mode, supported by STA 115 may be N×N.

At 405, a STA 115 may analyze traffic (e.g., identify a balance of search or listen mode power consumption and receive mode power consumption). In some cases, the traffic analysis may refer to observing packets (e.g., both a quantity of packets and durations of each packet) and spacing between packets during an observation window (e.g., see FIG. 6 description).

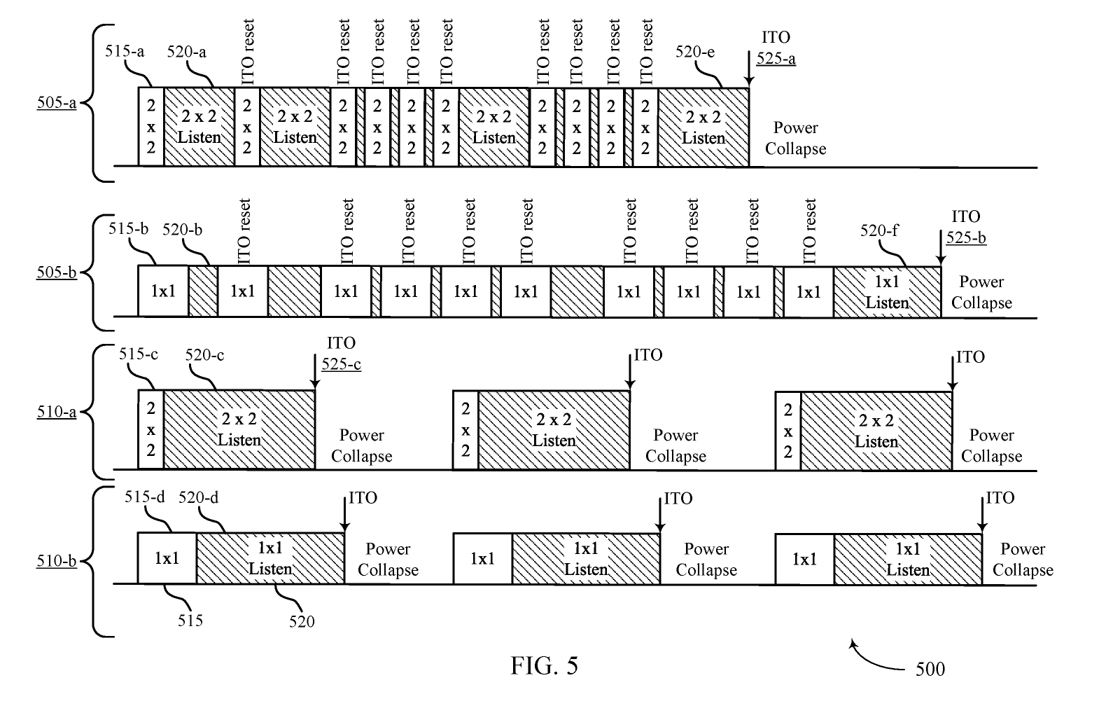

At 410, a STA 115 may perform an energy comparison for different modes of operation based on realizations of the traffic analysis of 405. The operations of 405 and 410 are described in more detail below, with reference to FIGS. 5 and 6. Based on performing the techniques described in the description of FIG. 6, if E_{MIMO}<E_{SISO} the STA 115 may proceed to 415, if E_{MIMO}>E_{SISO} the STA 115 may proceed to 425.

At 415, a STA 115 may, based on a determination that E_{MIMO}<E_{SISO}, then proceed to perform a channel matrix condition (q) check (e.g., to determine a matrix condition number (λₘₐₓ/λₘᵢₙ)). That is, the matrix condition number may refer to the ratio of the maximum to minimum eigenvalues of the channel matrix. In some cases, the correlation techniques described below may be referred to as determining the spread or distribution of channel eigenvalues. If the channel is uncorrelated (e.g., the channel matrix is orthogonal, where the matrix condition number is less than a correlation threshold), the STA 115 may proceed to 420 (e.g., to select or operate according to MIMO or a multiple chain configuration). If the channel is correlated (e.g., ill-conditioned), the STA 115 may proceed to 425 (e.g., to perform a chain correlation analysis). An ill-conditioned channel matrix (e.g., (λₘₐₓ/λₘᵢₙ)>correlation threshold) may lead to reduced MIMO efficiency (e.g., due to poor detection) or diversity/SIMO gains. That is, when the channel matrix indicates the channel is correlated, it may be difficult to separate spatial streams associated with multi chain configuration modes, reducing the effectiveness of such operation. A channel independence metric may be applied to decide stepping down to SISO or SIMO (e.g., to proceed to 425). Further, a channel condition number may be indirectly inferred via QR decomposition using the following (e.g., 2×2 MIMO detector):

$$η ( f ) = \frac{{\sum }_{k = 1}^{2} {\vert {r}_{12 , k} \vert}^{2}}{{\sum }_{k = 1}^{2} {r}_{11 , k}^{2} + {r}_{22 , k}^{2}} , \\ f = 1 , 2 , … , {N}_{FFT}$$

$$where , \\ Channel Matrix with {k}^{th} column permutation = QR = Q [ \begin{matrix}{r}_{11 , k} & {r}_{12 , k} \\ 0 & {r}_{22 , k}\end{matrix} ]$$

where k denotes the column permutation of the channel matrix, for example, by moving the k^{th} column to be the last column of the channel matrix. In the example above, the channel matrix is 2×2 and thus k takes the values of 1 and 2. In some examples, the η(f) metric may be averaged over a set of tones, f∈S(f), where S(f) is a set of tones over which the metric is computed and then compared against a threshold. For example, if η(f) exceeds a correlation threshold at 415, the STA 115 may proceed to 425. If η(f) is less than a correlation threshold at 415, the STA 115 may proceed to 420 (e.g., to operate in a MIMO configuration). In some cases, frequency selectivity may be derived from a channel estimator to guide a decimation process.

At 425, a STA 115 may analyze receive chain correlation (ρ) to determine whether the receive chains are correlated or independent. The determination that the receive chains are correlated may be based on identifying that the receive chain correlation (ρ) value exceeds a certain threshold. Similarly, the determination that the receive chains are independent (or uncorrelated) may be based on identifying that the receive chain correlation (ρ) value does not exceed such threshold. At 425, the STA 115 may have determined that MIMO is not desirable (e.g., due to matrix channel correlation analysis at 415 or due to the energy comparison at 410) and that a reduced chain configuration mode is more appropriate (e.g., for power consumption efficiency). If the chains are correlated (e.g., p is above a correlation threshold), there may not be enough diversity gain to justify additional receive chains. As such, STA 115 may proceed to 430 and operate in a SISO configuration mode, which may result in power savings. If the chains are uncorrelated (e.g., p is below the correlation threshold), the STA may proceed to 435, and perform chain power imbalance analysis.

At 435, a STA 115 may perform a chain power imbalance (α) analysis. In some cases, chain power imbalance may refer to a received signal strength indicator (RSSI) difference across chains, though other power measurement values or indicators may be used in other examples. If the chain power imbalance is high (e.g., α is above a chain power imbalance threshold) there may not be enough diversity gain to justify additional receive chains and the STA 115 may proceed to 440 and operate in a SISO configuration mode, which may result in power savings. If the chain power imbalance is low (e.g., a is below a chain power imbalance threshold), an additional check may be performed (e.g., the STA 115 proceeds to 445).

At 445, a STA 115 may perform a signal to noise ratio (SNR) analysis. The SNR analysis may be performed over time using a number of sample points over time. If STA 115 determines that the SNR is in good condition (e.g., because there is a high SNR, or the SNR exceeds a threshold) the STA 115 may proceed to 450 and operate in a SISO mode. The SNR may be determined to be in good condition because there is a high SNR, or the SNR exceeds a certain threshold, or the SNR exceeds a certain threshold for a certain amount of time. In such conditions, the SNR conditions may compliment single receive chain operation, which may result in further power savings. If the SNR is low (e.g., the SNR is below a threshold, or below a threshold for a certain period of time) the STA 115 may proceed to 455 and operate in a SIMO mode, as the increased diversity may be desirable to help overcome or alleviate low SNR conditions. That is, with good SNR conditions, receive diversity gain may be traded for power savings (e.g., by proceeding to 450 to operate in a SISO mode) and with poor SNR conditions, increased power consumption associated with operation of additional receive chain or chains (e.g., by proceeding to 455 to operate in a SIMO mode) may be desirable due to increased receive diversity gain.

Thus, dynamic channel rank selection may be performed according to flow diagram 400. A STA 115 may operate in a MIMO configuration mode if the energy associated with MIMO operation is less than energy associated with SISO operation for a given traffic pattern, and if a channel matrix is uncorrelated such that the channel conditions warrant spatial multiplexing. Further, if the energy associated with SISO operation is less than energy associated with MIMO operation or the energy associated with MIMO operation is less than energy associated with SISO operation but there is strong correlation of the channel matrix, the STA 115 may operate in a reduced chain configuration mode. If the STA 115 operates in a reduced chain configuration mode, and the receive chains are uncorrelated, there is low chain power imbalance, and low SNR conditions, the STA 115 may operate in a SIMO configuration mode, as the additional receive diversity gain may be desirable. Otherwise, if the STA 115 operates in a reduced chain configuration mode, the STA 115 may operate in a SISO configuration mode to reduce power consumption (e.g., that would otherwise be consumed by operation of the additional receive chain).

FIG. 5 illustrates an example of a timing diagram 500 that supports dynamic chain configuration selection in accordance with various aspects of the present disclosure. In some examples, timing diagram 500 may implement aspects of wireless communications system 100. Timing diagram 500 may illustrate aspects of communications received by a STA 115 over a wireless channel. The scenarios discussed in more detail below may illustrate aspects of how the energy efficiency of a chain configuration mode may vary with communication conditions, such as throughput. In some cases, timing diagram 500 may illustrate aspects of step 410 as discussed with reference to FIG. 4. For example, timing diagram 500 illustrates a high throughput scenario 505 and a low throughput scenario 510. Further, timing diagram 500 may illustrate multi chain configuration operation in a high throughput scenario 505-a, a single chain configuration operation in a high throughput scenario 505-b, multi chain configuration operation in a low throughput scenario 510-a, and a single chain configuration operation in a low throughput scenario 510-b. High throughput scenarios 505 and low throughput scenarios 510 may illustrate packets 515 as received by a STA 115, as well as listen intervals 520.

Listen intervals 520 may refer to intervals the STA 115 continues to monitor for incoming traffic until another packet 515 is received, or an inactivity timeout duration is reached (e.g., at ITO 525 points in time). A listen interval may refer to or be an inactivity interval. In some cases, STAs 115 may power down (e.g., power collapse) at ITOs 525, due to an inactivity timer expiring prior to reception of additional traffic (e.g., an additional packet 515). As an example, for multi chain configuration operation in a high throughput scenario 505-a, an inactivity timer associated with listen interval 520-e may expire at ITO 525-a (e.g., a packet 515 may not be received prior to the expiration of the listen interval 520-e), in which case a STA 115 may collapse power.

In high throughput scenarios 505, the mean time or duration between received packets 515 may be below a threshold (e.g., packets 515 may be received relatively frequently compared to low throughput scenarios 510). When traffic (e.g., packets 515) arrives, the receiver of a STA 115 may decode packets 515 with higher energy efficiency when operating in a MIMO configuration mode, e.g., packets 515 may be received with higher energy efficiency in high throughput scenario 505-a compared to high throughput scenario 505-b, due to the multi chain configuration operation. That is, during reception periods (e.g., periods associated with receiving packets 515), multi chain configuration operation may result in improved energy efficiency associated with reception of packets 515 as discussed in more detail with reference to FIG. 2. Additional energy consumed during listen intervals 520 may have reduced effect on overall energy efficiency in high throughput scenarios 505, as listen intervals 520 may be short in duration due to the more rapid succession of packets 515.

In low throughput scenarios 510, the mean time or duration between received packets 515 may be above a threshold (e.g., packets 515 may be received relatively infrequently compared to high throughput scenarios 505). When traffic (e.g., packets 515) arrives, the receiver of a STA 115 may decode packets 515 with higher energy efficiency when operating in a SISO configuration mode, e.g., packets 515 may be received with higher energy efficiency in low throughput scenario 510-b compared to low throughput scenario 510-a, due to the infrequent arrival of packets 515 and the reduced energy consumption associated with single chain configuration operation. That is, during reception periods (e.g., periods associated with receiving packets 515), single chain configuration operation may result in improved energy efficiency associated with reception of packets 515 as discussed in more detail with reference to FIG. 2. For multi chain configuration operation in low throughput scenario 510-a, additional energy consumed during listen intervals 520 may have an increased effect on overall energy efficiency, as listen intervals 520 may be longer in duration due to the less rapid succession of packets 515.

However, this may not always be the case. As discussed above with reference to FIGS. 2 and 4, additional criteria may be used prior to determining single chain configuration operation. That is, low throughput scenarios 510 may indicate MIMO operation may not be desired, but additional channel analysis may be performed to determine whether SISO, SIMO, etc., may be more energy efficient in such low throughput scenarios. In general, for high throughput scenarios, e.g., where packet spacing is below a threshold, multi chain configuration operation such as MIMO may be employed. In low throughput scenarios, e.g., where packet spacing is above a threshold, multi chain configuration operation such as MIMO may not be employed, and additional analysis may be performed to determine a lower dimension or non-MIMO (e.g., SIMO, SISO, etc.) configuration mode for operation, as further discussed above with reference to FIG. 4.

FIG. 6 illustrates an example of a timing diagram 600 that supports dynamic chain configuration selection in accordance with various aspects of the present disclosure. In some examples, timing diagram 600 may implement aspects of wireless communications system 100. Timing diagram 600 may illustrate aspects of communications received by a STA 115 over a wireless channel. The scenarios discussed in more detail below may illustrate aspects of how the energy efficiency may be improved via dynamic chain configuration mode selection based on closed loop feedback (e.g., time domain interactions of traffic patterns). In some cases, timing diagram 600 may illustrate aspects of flow diagram 400 (e.g., 410) as discussed with reference to FIG. 4. Timing diagram 600 may illustrate a multi chain configuration operation timeline 610 and a single chain configuration operation timeline 615 over an observation window 605, over which packet reception is observed. For example, packet reception observation may include identifying how many packets are received within an observation window 605. For example, a STA 115 may observe packet reception and resulting power consumption over an observation window 605 for one of timelines 610 or 615 (e.g., multi chain configuration operation timeline 610), and may estimate (e.g., through inference or prediction) what would have been the power consumption over the same observation window 605 for another mode of operation (e.g., single chain configuration operation timeline 615).

The power consumption associated with operation of different chain configuration modes may be known by STAs 115. As such, STAs 115 may, based on an identified number of received packets within an observation window 605 (e.g., 100 ms), known durations of all received packets, and known power consumption associated with operation of different chain configuration modes, estimate the power consumption or energy efficiency associated with other configurations modes, should they be employed for a similar scenario as observed within the observation window 605. That is, STAs 115 may estimate power consumption for the one or more configuration modes over an observation window 605, based on the identified packets (e.g., number of packets, durations of each packet, etc.) within the observation window 605 and known power consumption values (e.g., P₂ᵣ, P₂ₗ, P₁ᵣ, P₁ₗ, and P_{off}) associated with receive mode operation (e.g., receiving a packet), listen mode operation (e.g., listening between packets), and low power mode operation or network listen (e.g., following expiration of an ITO).

Therefore, a STA 115 may operate in a MIMO (or SISO) mode for some time (e.g., an observation window 605) and determine an inter-packet spacing (e.g., search or listen durations 625), packet duration (e.g., receive durations 620), and network sleep durations 630 to identify patterns. Such patterns observed over an observation window 605 may be used to infer, hypothesize, estimated, or otherwise determine energy efficiency associated with operation of other configuration modes. The observed pattern in MIMO (or SISO) may be mapped to alternate modes of operation such as SISO (or MIMO). Therefore, energy efficiency may be estimated for other modes of operation. That is, listen duration 625-a, receive duration 620-a, and network sleep duration 630-a may be used to estimate listen duration 625-b, receive duration 620-b, and network sleep duration 630-b as discussed in more detail below. Listen duration 625-b, receive duration 620-b, and network sleep duration 630-b may be used along with known power consumption values (e.g., P₁ᵣ P₁ₗ, and P_{off}) to, estimate power consumption, and thus energy efficiency associated with other configuration mode operation. Using all the above information, STAs 115 may compare energy efficiency (e.g., evaluate if E_{SISO}>E_{MIMO}), and maintain record for N observation windows and dynamically apply MIMO vs SISO and notify APs 105 accordingly.

That is, observed time values (e.g., T₂ᵣ, T₂ᵣᵢ, T₁ᵣ, T₂ᵣᵢ, T₂ₗ, etc.) and power consumption values (e.g., P₂ᵣ, P₂ₗ, P₁ᵣ, P₁ₗ, and P_{off}) may be used to determine energy values associated with different configuration modes (e.g., E_{1×1} and E_{2×2}). For example, for every T_{obs} the following process may be used:

```
{
For every packet “i”
{
      T_{2R} = T_{2R} + T_{2Ri} (measured)
      T_{1R} = T_{1R} + (2 × T_{2Ri}) (inferred)
      T_{2L} = T_{2L} + T_{2Li} (measured) (Tₛₜₐᵣₜᵢ − Tₛₜₐᵣₜ₍ᵢ₋₁₎)
            T_{1L} = T_{1L} + T_{1Li} (measured) (Tₛₜₐᵣₜᵢ − Tₛₜₐᵣₜ₍ᵢ₋₁₎)
            N++ #number of packet
      }
      T_{off2} = T_{obs} − T_{2R} − T_{2L}
      T_{off1} = T_{obs} − T_{1R} − T_{1L}
}
```

Therefore, the energies (E) may be determined for the channel

E_{2off}=P_{off}*T_{off}

E_{2R}=P_{2R}*T_{2R}

E_{2L}=P_{2L}*T_{2L}

E_{2×2}=E_{2L}+E_{2R}+E_{2off}

E_{1off}=P_{off}*T_{off}

E_{1R}=P_{1R}*T_{1R}

E_{1L}=P_{1L}*T_{1L}

E_{1×1}=E_{1L}+E_{1R}+E_{1off}

In the equations above, the subscripts (e.g., ‘1’, ‘2’, ‘L’, ‘R’, ‘i’, and ‘off’) define conditions associated with the different values of time (T), power (P), and energy (E). For example a subscript of ‘1’ or ‘2’ may indicate a N×N chain configuration and a subscript of ‘R’ or ‘L’ may indicate a UE operation mode (e.g., E_{2R} may refer to an energy value for 2×2 chain configuration reception mode, T_{1L} may refer to a time value or time duration for a 1×1 chain configuration listen mode, P_{2L} may refer to a power value for a 2×2 chain configuration listen mode, etc.). Further, a subscript of ‘off’ may refer to a low power operation mode (e.g., after expiration of an ITO). Lastly, an T subscript may refer to a value that is based on a packet by packet instance (e.g., T_{2Li} may refer to a time value or time duration for reception of an ‘i’th packet when operating in a 2×2 chain configuration listen mode, calculated via Tₛₜₐᵣₜᵢ−Tₛₜₐᵣₜ₍ᵢ₋₁₎ or the start time of a current packet less the start time of a previously received packet). In some cases, as discussed herein, some values (e.g., P₂ᵣ, P₂ₗ, P₁ᵣ, P₁ₗ, and P_{off}) may be known values (e.g., estimation values, as they may vary relatively little over time) and determined based on a lookup table to perform calculations discussed above.

As an example, an STA 115 may operate in a multi chain configuration mode (e.g., a 2×2 MIMO operation mode), and may consume power as shown in multi chain configuration operation timeline 610. The STA 115 may operate two receive chains at a total receive power level (e.g., P₂ᵣ) for a receive duration 620-a (e.g., a duration T₂ᵣᵢ). The STA 115 may then estimate power consumption for a hypothetical single chain configuration mode operation. That is, the STA 115 may estimate that twice the amount of time may be necessary to receive the same first packet and the receive power level may be reduced (e.g., due to hypothetical operation of half the number of receive chains). For example, an STA 115 may estimate hypothetical operation of a single chain configuration mode for the same scenario over observation window 605. That is, a receive power level (e.g., P₁ᵣ) for a receive duration 620-b (e.g., a duration T₁ᵣᵢ, corresponding to a known length of the first packet) may be estimated. Similarly, the STA may know power consumption levels associated with operation of different chain configurations during listen intervals. If STA 115 operates at a power level P₂ₗ for a listen duration 625-a, the STA may hypothesize operation at a known power level of, for example, P₁ₗ for a listen duration 625-b. As such, STAs 115 may estimate energy consumption (e.g., aggregated power levels multiplied by time) for other configuration modes assuming an observed scenario over an observation window 605. Therefore, STAs 115 may compare energy efficiency for different modes of operation (e.g., for one or multiple observation windows), which may be used for dynamic configuration mode determinations as described herein.

In some cases, timeline 615 may illustrate operation of a single chain configuration (e.g., a 1×1 configuration mode), which may be referred to as a reduced dimension mode. However, aspects of timing diagram 600 may be applied to other configuration modes by analogy, without departing from the scope of the present disclosure. For example, timeline 610 and timeline 615 may be analogous to operation of any multi chain, or N×N configuration mode and any reduced dimension configuration mode. In general, reduced dimension configuration modes may be associated with longer reception times and reduced power consumption during reception times. As discussed above, power levels associated with receive mode operation and listen mode operation may be known (e.g., referenced in a lookup table). As such, based on an assumption the time to receive a given packet is directly related to the number of chains or the dimension configuration mode (e.g., 1×1 reception takes twice as long as 2×2 reception, N×N reception is complete N times faster than 1×1 reception, etc.), energy consumption may be observed for an operating configuration mode during an observation window, and energy consumption may be estimated or inferred for other supported configuration modes given the information obtained during the observation window, and known power consumption estimates. That is, an energy comparison may be made for various chain configuration modes based on information obtained in an observation window via equations and operations analogous to the equations above. Therefore, determinations may be made, based on observation windows, when it may be beneficial to reduce a number of chains in operation (at STA 115, or AP 105, or both) or drop to a reduced dimension mode as discussed with reference to 410 of FIG. 4. Specifically, FIG. 6 may refer to the time domain analysis involved in dynamic channel rank selection via channel analysis techniques described herein.

FIG. 7 shows a block diagram 700 of a wireless device 705 that supports dynamic chain configuration selection in accordance with aspects of the present disclosure. Wireless device 705 may be an example of aspects of STA 115, or in some cases an AP 105, as described herein. Wireless device 705 may include receiver 710, communications manager 715, and transmitter 720. Wireless device 705 may also include a processor. Each of these components may be in communication with one another (e.g., via one or more buses).

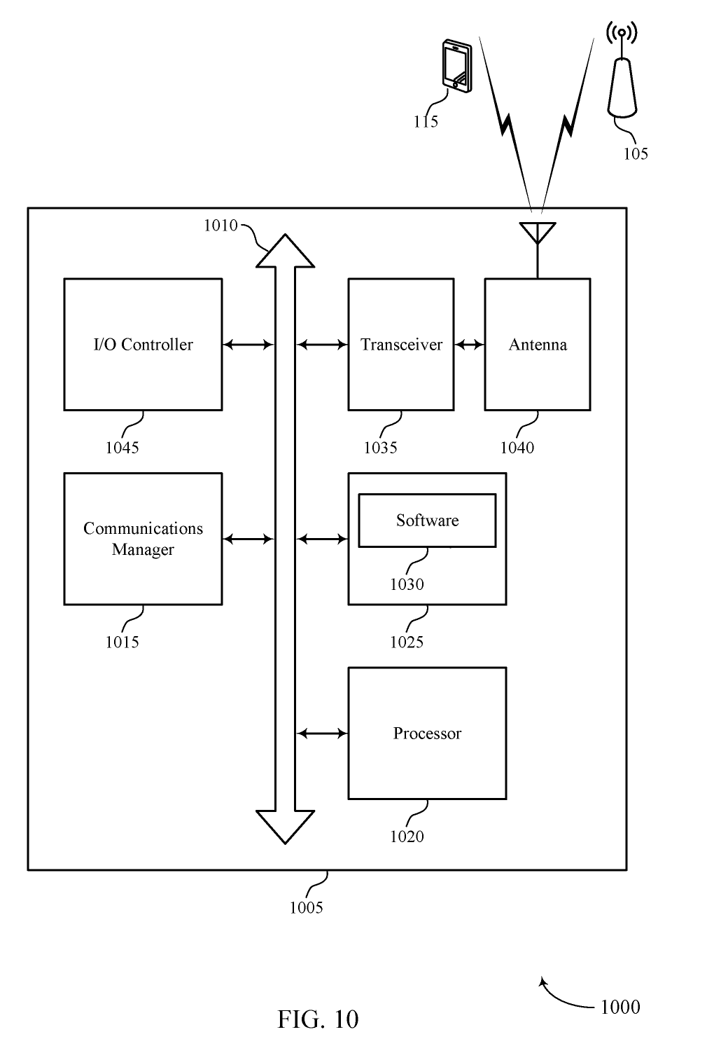

Receiver 710 may receive information such as packets, user data, or control information associated with various information channels (e.g., control channels, data channels, and information related to dynamic chain configuration selection, etc.). Information may be passed on to other components of the device. The receiver 710 may be an example of aspects of the transceiver 1035 described with reference to FIG. 10. The receiver 710 may utilize a single antenna or a set of antennas.

Communications manager 715 may be an example of aspects of the communications manager 1015 described with reference to FIG. 10. Communications manager 715 and/or at least some of its various sub-components may be implemented in hardware, software executed by a processor, firmware, or any combination thereof. If implemented in software executed by a processor, the functions of the communications manager 715 and/or at least some of its various sub-components may be executed by a general-purpose processor, a digital signal processor (DSP), an application-specific integrated circuit (ASIC), an field-programmable gate array (FPGA) or other programmable logic device, discrete gate or transistor logic, discrete hardware components, or any combination thereof designed to perform the functions described in the present disclosure. The communications manager 715 and/or at least some of its various sub-components may be physically located at various positions, including being distributed such that portions of functions are implemented at different physical locations by one or more physical devices. In some examples, communications manager 715 and/or at least some of its various sub-components may be a separate and distinct component in accordance with various aspects of the present disclosure. In other examples, communications manager 715 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

Communications manager 715 may monitor, over a time duration, traffic on a wireless channel using a first chain configuration mode of the wireless device, determine a first energy value based on the traffic monitored using the first chain configuration mode, and determine a second energy value for a second chain configuration mode of the wireless device based on the first energy value. Communications manager 715 may then compare the first energy value to the second energy value, perform a channel metric computation on the traffic, and switch from operating the wireless device in the first chain configuration mode to operating the wireless device in the second chain configuration mode to communicate on the wireless channel based on the comparison and a result of the channel metric computation. The communications manager 715 may also monitor, over a time duration, traffic on a wireless channel using a MIMO operation mode, determine a first energy value based on the traffic monitored using the MIMO operation mode, determine a second energy value for a SISO operation mode for the wireless device based on the first energy value, and perform a channel metric computation on the traffic if the first energy value is less than the second energy value. Communications manager 715 may operate in the MIMO operation mode if a result of the channel correlation procedure indicates that a channel matrix associated with the monitored traffic has a correlation value less than a first threshold. Communications manager 715 may determine, if the first energy value is greater than the second energy value or if the result of the channel metric computation indicates that the channel matrix has the correlation value greater than the first threshold, a chain correlation value for a set of receive chains of the wireless device. Communications manager 715 may switch from operating the wireless device in the MIMO operation mode to operating the wireless device in the SISO operation mode if the chain correlation value is greater than a second threshold. Communications manager 715 may determine, if the chain correlation value is less than the second threshold, a chain power imbalance value for a set of receive chains of the wireless device and switch from operating the wireless device in the MIMO operation mode to operating the wireless device in the SISO operation mode if the chain power imbalance value is greater than a third threshold. Communications manager 715 may determine, if the chain power imbalance value is less than the third threshold, a SNR for the monitored traffic and switch from operating the wireless device in the MIMO operation mode to operating the wireless device in the SISO operation mode if the SNR is greater than a fourth threshold. Communications manager 715 may switch from operating the wireless device in the MIMO operation mode to operating the wireless device in a SIMO operation mode if the SNR is less than the fourth threshold.

Transmitter 720 may transmit signals generated by other components of the device. In some examples, the transmitter 720 may be collocated with a receiver 710 in a transceiver module. For example, the transmitter 720 may be an example of aspects of the transceiver 1035 described with reference to FIG. 10. The transmitter 720 may utilize a single antenna or a set of antennas.

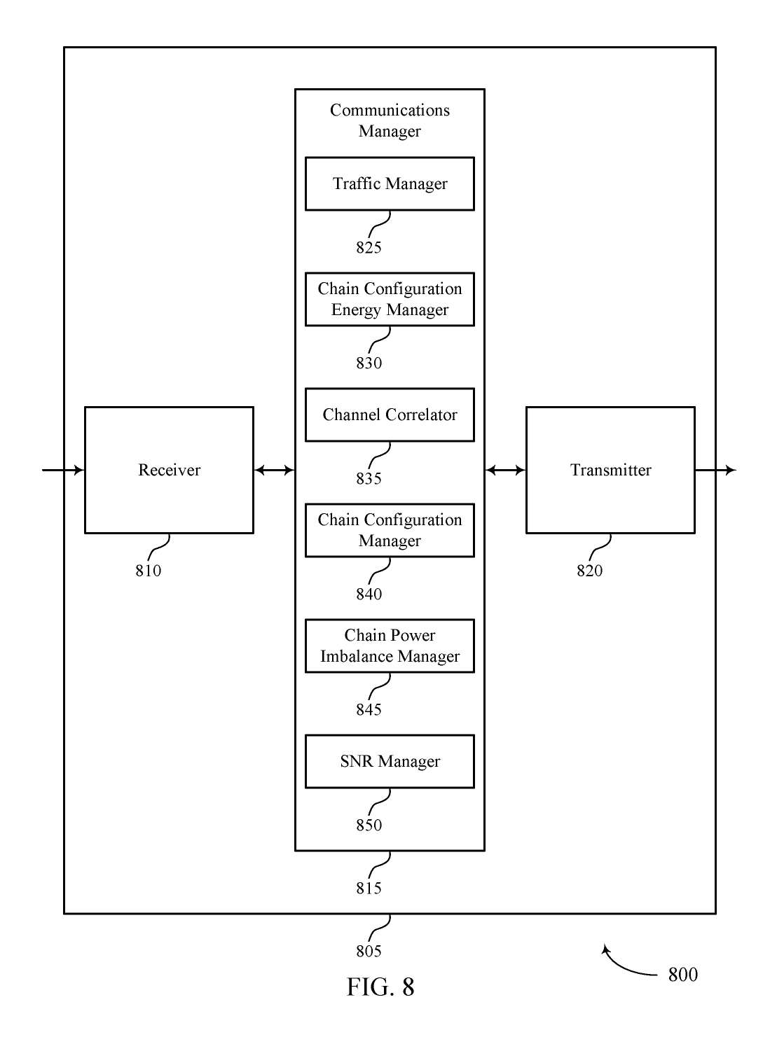

FIG. 8 shows a block diagram 800 of a wireless device 805 that supports dynamic chain configuration selection in accordance with aspects of the present disclosure. Wireless device 805 may be an example of aspects of a wireless device 705 or a STA 115 as described with reference to FIG. 7. Wireless device 805 may include receiver 810, communications manager 815, and transmitter 820. Wireless device 805 may also include a processor. Each of these components may be in communication with one another (e.g., via one or more buses).

Receiver 810 may receive information such as packets, user data, or control information associated with various information channels (e.g., control channels, data channels, and information related to dynamic chain configuration selection, etc.). Information may be passed on to other components of the device. The receiver 810 may be an example of aspects of the transceiver 1035 described with reference to FIG. 10. The receiver 810 may utilize a single antenna or a set of antennas.

Communications manager 815 may be an example of aspects of the communications manager 1015 described with reference to FIG. 10. Communications manager 815 may also include traffic manager 825, chain configuration energy manager 830, channel correlator 835, chain configuration manager 840, chain power imbalance manager 845, and SNR manager 850.

Traffic manager 825 may monitor, over a time duration, traffic on a wireless channel using a first chain configuration mode (e.g., a MIMO operation mode).

Chain configuration energy manager 830 may determine a first energy value based on the traffic monitored using the first chain configuration mode, determine a second energy value for a second chain configuration mode of the wireless device based on the first energy value and compare the first energy value to the second energy value. Chain configuration energy manager 830 may determine a first energy value based on the traffic monitored using the MIMO operation mode, determine a second energy value for a SISO operation mode for the wireless device based on the first energy value and determine the second energy value for the monitored traffic based on the second receive duration. Chain configuration energy manager 830 may determine, if the first energy value is greater than the second energy value or if the result of the channel metric computation indicates that the channel matrix has the correlation value greater than the first threshold, a chain correlation value for a set of receive chains of the wireless device, and apply the determined factor to the first receive duration to generate the second receive duration. Chain configuration energy manager 830 may determine the first energy value for the monitored traffic based on one or more of the listen duration, the listen power, the receive duration, the receive power, the sleep duration, and the sleep power, and determine, for the second chain configuration mode, a second receive duration for the monitored traffic based on the first receive duration. In some cases, determining, for the first chain configuration mode, the first energy value for the monitored traffic may include determining, for the first chain configuration mode, one or more of a listen power, a listen duration, a receive power, a receive duration, a sleep power, and a sleep duration for the monitored traffic during the time duration. In some cases, determining the second energy value may include determining, for the first chain configuration mode, a first receive duration for the monitored traffic, the first energy value being determined based on the first receive duration. In some cases, determining the second receive duration for the monitored traffic based on the first receive duration may include determining a factor to be applied to the first receive duration based on one or both of the first chain configuration mode and the second chain configuration mode.

Channel correlator 835 may perform a channel metric computation on the traffic and determine a chain correlation value for a set of receive chains of the wireless device. In some cases, switching from operating the wireless device in the first chain configuration mode to operating the wireless device in the second chain configuration mode is further based on the determined chain correlation value. Channel correlator 835 may determine that the chain correlation value exceeds a threshold, where switching from operating the wireless device in the first chain configuration mode to operating the wireless device in the second chain configuration mode is further based on the determination that the chain correlation value exceeds the threshold. Channel correlator 835 may perform a channel metric computation on the traffic if the first energy value is less than the second energy value. In some cases, performing the channel metric computation includes computing eigenvalues of a channel matrix and computing a ratio of a maximum eigenvalue to a minimum eigenvalue. Channel correlator 835 may then determine a channel condition number based at least in part on the ratio. Further, channel correlator 835 may compute eigenvalues of a channel matrix, compute a QR decomposition of the channel matrix for the wireless device, identify an R-matrix based at least in part on the QR decomposition, and determine a channel orthogonality based at least in part on elements of the identified R-matrix. In some cases, the second chain configuration mode includes a SISO operation mode.

Chain configuration manager 840 may switch from operating the wireless device in the first chain configuration mode to operating the wireless device in the second chain configuration mode to communicate on the wireless channel based on the energy value comparison and a result of the channel metric computation. Chain configuration manager 840 may operate in the MIMO operation mode if a result of the channel correlation procedure indicates that a channel matrix associated with the monitored traffic has a correlation value less than a first threshold and switch from operating the wireless device in the MIMO operation mode to operating the wireless device in the SISO operation mode if the chain correlation value is greater than a second threshold. Chain configuration manager 840 may switch from operating the wireless device in the MIMO operation mode to operating the wireless device in the SISO operation mode if the chain power imbalance value is greater than a third threshold. Chain configuration manager 840 may switch from operating the wireless device in the MIMO operation mode to operating the wireless device in the SISO operation mode if the SNR is greater than a fourth threshold, switch from operating the wireless device in the first chain configuration mode to operating the wireless device in the second chain configuration mode is based on the determination that the result of the channel metric computation is less than the threshold. Chain configuration manager 840 may switch from operating the wireless device in the MIMO operation mode to operating the wireless device in a SIMO operation mode if the SNR is less than the fourth threshold. In some cases, the first chain configuration mode is a SISO operation mode or a SIMO operation mode. In some cases, the second chain configuration mode includes a MIMO operation mode. In some cases, the first chain configuration mode is a MIMO operation mode. In some cases, the second chain configuration mode is a SISO operation mode or a SIMO operation mode. In some cases, the second chain configuration mode is a MIMO operation mode.

Chain power imbalance manager 845 may determine a chain power imbalance value for a set of receive chains of the wireless device, where switching from operating the wireless device in the first chain configuration mode to operating the wireless device in the second chain configuration mode is further based on the determined chain power imbalance value. Chain power imbalance manager 845 may determine that the chain power imbalance value exceeds a threshold, where switching from operating the wireless device in the first chain configuration mode to operating the wireless device in the second chain configuration mode is further based on the determination that the chain power imbalance value exceeds the threshold. Chain power imbalance manager 845 may determine, if the chain correlation value is less than the second threshold, a chain power imbalance value for a set of receive chains of the wireless device. In some cases, the second chain configuration mode includes a SISO operation mode.

SNR manager 850 may determine a SNR for the monitored traffic, where switching from operating the wireless device in the first chain configuration mode to operating the wireless device in the second chain configuration mode is further based on the determined SNR. SNR manager 850 may determine that the SNR exceeds a threshold, where switching from operating the wireless device in the first chain configuration mode to operating the wireless device in the second chain configuration mode is further based on the determination that the SNR exceeds the threshold. SNR manager 850 may determine that the SNR is less than a threshold, where switching from operating the wireless device in the first chain configuration mode to operating the wireless device in the second chain configuration mode is further based on the determination that the SNR is less than the threshold. SNR manager 850 may determine, if the chain power imbalance value is less than the third threshold, a SNR for the monitored traffic. In some cases, the second chain configuration mode includes a SISO operation mode. In some cases, the second chain configuration mode includes a SIMO operation mode.

Transmitter 820 may transmit signals generated by other components of the device. In some examples, the transmitter 820 may be collocated with a receiver 810 in a transceiver module. For example, the transmitter 820 may be an example of aspects of the transceiver 1035 described with reference to FIG. 10. The transmitter 820 may utilize a single antenna or a set of antennas.

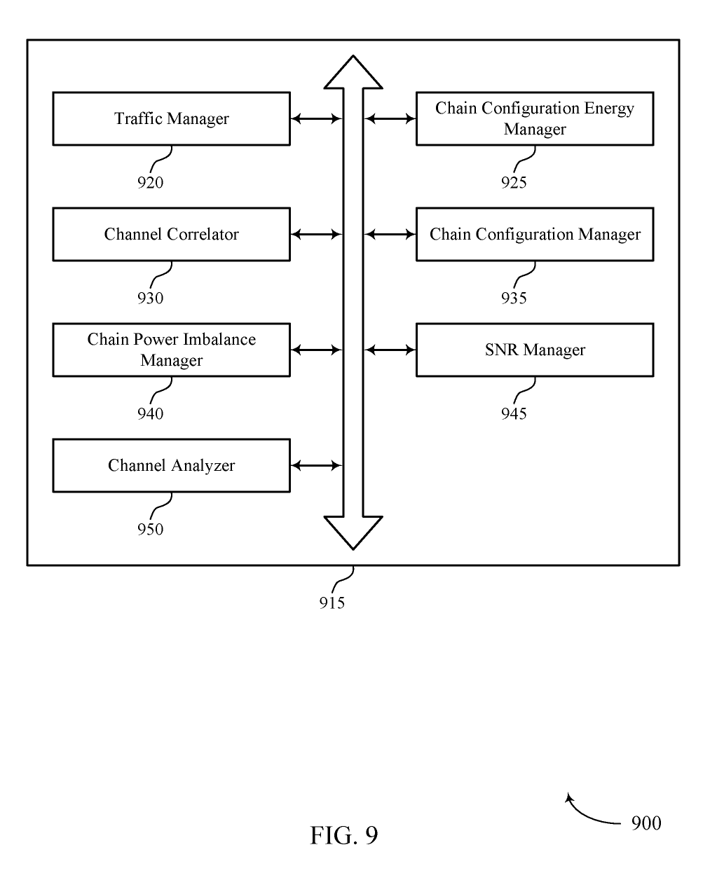

FIG. 9 shows a block diagram 900 of a communications manager 915 that supports dynamic chain configuration selection in accordance with aspects of the present disclosure. The communications manager 915 may be an example of aspects of a communications manager 715, a communications manager 815, or a communications manager 1015 described with reference to FIGS. 7, 8, and 10. The communications manager 915 may include traffic manager 920, chain configuration energy manager 925, channel correlator 930, chain configuration manager 935, chain power imbalance manager 940, SNR manager 945, and channel analyzer 950. Each of these modules may communicate, directly or indirectly, with one another (e.g., via one or more buses).

Traffic manager 920 may monitor, over a time duration, traffic on a wireless channel using a first chain configuration mode of the wireless device and monitor, over a time duration, traffic on a wireless channel using a MIMO operation mode.

Chain configuration energy manager 925 may determine a first energy value based on the traffic monitored using the first chain configuration mode, determine a second energy value for a second chain configuration mode of the wireless device based on the first energy value, and compare the first energy value to the second energy value. Chain configuration energy manager 925 may determine a first energy value based on the traffic monitored using the MIMO operation mode, determine a second energy value for a SISO operation mode for the wireless device based on the first energy value, determine the second energy value for the monitored traffic based on the second receive duration. Chain configuration energy manager 925 may determine the first energy value for the monitored traffic based on one or more of the listen duration, the listen power, the receive duration, the receive power, the sleep duration, and the sleep power, and determine, for the second chain configuration mode, a second receive duration for the monitored traffic based on the first receive duration. In some cases, determining, for the first chain configuration mode, the first energy value for the monitored traffic includes determining, for the first chain configuration mode, one or more of a listen power, a listen duration, a receive power, a receive duration, a sleep power, and a sleep duration for the monitored traffic during the time duration. In some cases, determining the second energy value includes determining, for the first chain configuration mode, a first receive duration for the monitored traffic, the first energy value being determined based on the first receive duration. In some cases, determining the second receive duration for the monitored traffic based on the first receive duration includes determining a factor to be applied to the first receive duration based on one or both of the first chain configuration mode and the second chain configuration mode.

Channel correlator 930 may perform a channel metric computation on the traffic and determine a chain correlation value for a set of receive chains of the wireless device, where switching from operating the wireless device in the first chain configuration mode to operating the wireless device in the second chain configuration mode is further based on the determined chain correlation value. Channel correlator 930 may determine that the chain correlation value exceeds a threshold, where switching from operating the wireless device in the first chain configuration mode to operating the wireless device in the second chain configuration mode is further based on the determination that the chain correlation value exceeds the threshold. Channel correlator 930 may perform a channel metric computation on the traffic if the first energy value is less than the second energy value. In some cases, performing the channel metric computation includes computing eigenvalues of a channel matrix and computing a ratio of a maximum eigenvalue to a minimum eigenvalue. Channel correlator 930 may then determine a channel condition number based at least in part on the ratio. Further, channel correlator 930 may compute eigenvalues of a channel matrix, compute a QR decomposition of the channel matrix for the wireless device, identify an R-matrix based at least in part on the QR decomposition, and determine a channel orthogonality based at least in part on elements of the identified R-matrix. In some cases, the second chain configuration mode includes a SISO operation mode.

Chain configuration manager 935 may switch from operating the wireless device in the first chain configuration mode to operating the wireless device in the second chain configuration mode to communicate on the wireless channel based on the energy comparison and a result of the channel metric computation. Chain configuration manager 935 may operate in the MIMO operation mode if a result of the channel correlation procedure indicates that a channel matrix associated with the monitored traffic has a correlation value less than a first threshold, switch from operating the wireless device in the MIMO operation mode to operating the wireless device in the SISO operation mode if the chain correlation value is greater than a second threshold. Chain configuration manager 935 may switch from operating the wireless device in the MIMO operation mode to operating the wireless device in the SISO operation mode if the chain power imbalance value is greater than a third threshold. Chain configuration manager 935 may switch from operating the wireless device in the MIMO operation mode to operating the wireless device in the SISO operation mode if the SNR is greater than a fourth threshold. Chain configuration manager 935 may switch from operating the wireless device in the first chain configuration mode to operating the wireless device in the second chain configuration mode is based on the determination that the result of the channel metric computation is less than the threshold. Chain configuration manager 935 may switch from operating the wireless device in the MIMO operation mode to operating the wireless device in a SIMO operation mode if the SNR is less than the fourth threshold. In some cases, the first chain configuration mode is a SISO operation mode or a SIMO operation mode. In some cases, the second chain configuration mode includes a MIMO operation mode. In some cases, the first chain configuration mode is a MIMO operation mode. In some cases, the second chain configuration mode is a SISO operation mode or a SIMO operation mode. In some cases, the second chain configuration mode is a MIMO operation mode.

Chain power imbalance manager 940 may determine a chain power imbalance value for a set of receive chains of the wireless device, where switching from operating the wireless device in the first chain configuration mode to operating the wireless device in the second chain configuration mode is further based on the determined chain power imbalance value. Chain power imbalance manager 940 may determine that the chain power imbalance value exceeds a threshold, where switching from operating the wireless device in the first chain configuration mode to operating the wireless device in the second chain configuration mode is further based on the determination that the chain power imbalance value exceeds the threshold. Chain power imbalance manager 940 may determine, if the chain correlation value is less than the second threshold, a chain power imbalance value for a set of receive chains of the wireless device. In some cases, the second chain configuration mode includes a SISO operation mode.

SNR manager 945 may determine a SNR for the monitored traffic, where switching from operating the wireless device in the first chain configuration mode to operating the wireless device in the second chain configuration mode is further based on the determined SNR. SNR manager 945 may determine that the SNR exceeds a threshold, where switching from operating the wireless device in the first chain configuration mode to operating the wireless device in the second chain configuration mode is further based on the determination that the SNR exceeds the threshold. SNR manager 945 may determine that the SNR is less than a threshold, where switching from operating the wireless device in the first chain configuration mode to operating the wireless device in the second chain configuration mode is further based on the determination that the SNR is less than the threshold, and determine, if the chain power imbalance value is less than the third threshold, a SNR for the monitored traffic. In some cases, the second chain configuration mode includes a SISO operation mode. In some cases, the second chain configuration mode includes a SIMO operation mode.

Channel analyzer 950 may sub-sample one or more tones from a set of tones of the monitored traffic and determine a wireless channel metric based on the sub-sampled one or more tones, where the wireless channel metric is a channel condition number. Channel analyzer 950 may determine a channel frequency coherence for the wireless channel and select a set of the one or more tones to be sampled from the set of tones based on the determined channel coherence.

FIG. 10 shows a diagram of a system 1000 including a device 1005 that supports dynamic chain configuration selection in accordance with aspects of the present disclosure. Device 1005 may be an example of or include the components of wireless device 705, wireless device 805, or a STA 115 or AP 105 as described above, e.g., with reference to FIGS. 7 and 8. Device 1005 may include components for bi-directional voice and data communications including components for transmitting and receiving communications, including communications manager 1015, processor 1020, memory 1025, software 1030, transceiver 1035, antenna 1040, and I/O controller 1045. These components may be in electronic communication via one or more buses (e.g., bus 1010).

Processor 1020 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, processor 1020 may be configured to operate a memory array using a memory controller. In other cases, a memory controller may be integrated into processor 1020. Processor 1020 may be configured to execute computer-readable instructions stored in a memory to perform various functions (e.g., functions or tasks supporting dynamic chain configuration selection).

Memory 1025 may include random access memory (RAM) and read only memory (ROM). The memory 1025 may store computer-readable, computer-executable software 1030 including instructions that, when executed, cause the processor to perform various functions described herein. In some cases, the memory 1025 may contain, among other things, a basic input/output system (BIOS) which may control basic hardware or software operation such as the interaction with peripheral components or devices.

Software 1030 may include code to implement aspects of the present disclosure, including code to support dynamic chain configuration selection. Software 1030 may be stored in a non-transitory computer-readable medium such as system memory or other memory. In some cases, the software 1030 may not be directly executable by the processor but may cause a computer (e.g., when compiled and executed) to perform functions described herein.

Transceiver 1035 may communicate bi-directionally, via one or more antennas, wired, or wireless links as described above. For example, the transceiver 1035 may represent a wireless transceiver and may communicate bi-directionally with another wireless transceiver. The transceiver 1035 may also include a modem to modulate the packets and provide the modulated packets to the antennas for transmission, and to demodulate packets received from the antennas.

In some cases, the wireless device may include a single antenna 1040. However, in some cases the device may have more than one antenna 1040, which may be capable of concurrently transmitting or receiving multiple wireless transmissions.

I/O controller 1045 may manage input and output signals for device 1005. I/O controller 1045 may also manage peripherals not integrated into device 1005. In some cases, I/O controller 1045 may represent a physical connection or port to an external peripheral. In some cases, I/O controller 1045 may utilize an operating system such as iOS®, ANDROID®, MS-DOS®, MS-WINDOWS®, OS/2®, UNIX®, LINUX®, or another known operating system. In other cases, I/O controller 1045 may represent or interact with a modem, a keyboard, a mouse, a touchscreen, or a similar device. In some cases, I/O controller 1045 may be implemented as part of a processor. In some cases, a user may interact with device 1005 via I/O controller 1045 or via hardware components controlled by I/O controller 1045.

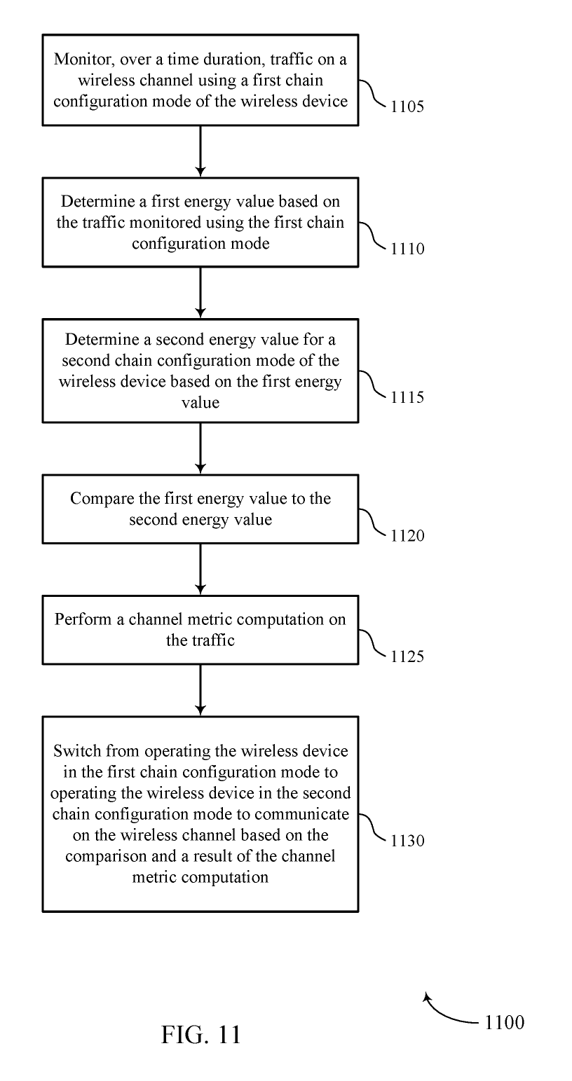

FIG. 11 shows a flowchart illustrating a method 1100 for dynamic chain configuration selection in accordance with aspects of the present disclosure. The operations of method 1100 may be implemented by a STA 115 or its components as described herein. For example, the operations of method 1100 may be performed by a communications manager as described with reference to FIGS. 7 through 10. In some examples, a STA 115 may execute a set of codes to control the functional elements of the device to perform the functions described below. Additionally or alternatively, the STA 115 may perform aspects of the functions described below using special-purpose hardware.

At block 1105 the STA 115 may monitor, over a time duration, traffic on a wireless channel using a first chain configuration mode of the wireless device. The operations of block 1105 may be performed according to the methods described herein. In certain examples, aspects of the operations of block 1105 may be performed by a traffic manager as described with reference to FIGS. 7 through 10.

At block 1110 the STA 115 may determine a first energy value based at least in part on the traffic monitored using the first chain configuration mode. The operations of block 1110 may be performed according to the methods described herein. In certain examples, aspects of the operations of block 1110 may be performed by a chain configuration energy manager as described with reference to FIGS. 7 through 10.

At block 1115 the STA 115 may determine a second energy value for a second chain configuration mode of the wireless device based at least in part on the first energy value. The operations of block 1115 may be performed according to the methods described herein. In certain examples, aspects of the operations of block 1115 may be performed by a chain configuration energy manager as described with reference to FIGS. 7 through 10.

At block 1120 the STA 115 may compare the first energy value to the second energy value. The operations of block 1120 may be performed according to the methods described herein. In certain examples, aspects of the operations of block 1120 may be performed by a chain configuration energy manager as described with reference to FIGS. 7 through 10.

At block 1125 the STA 115 may perform a channel metric computation on the traffic. The operations of block 1125 may be performed according to the methods described herein. In certain examples, aspects of the operations of block 1125 may be performed by a channel correlator as described with reference to FIGS. 7 through 10.

At block 1130 the STA 115 may switch from operating the wireless device in the first chain configuration mode to operating the wireless device in the second chain configuration mode to communicate on the wireless channel based at least in part on the comparison and a result of the channel metric computation. The operations of block 1130 may be performed according to the methods described herein. In certain examples, aspects of the operations of block 1130 may be performed by a chain configuration manager as described with reference to FIGS. 7 through 10.

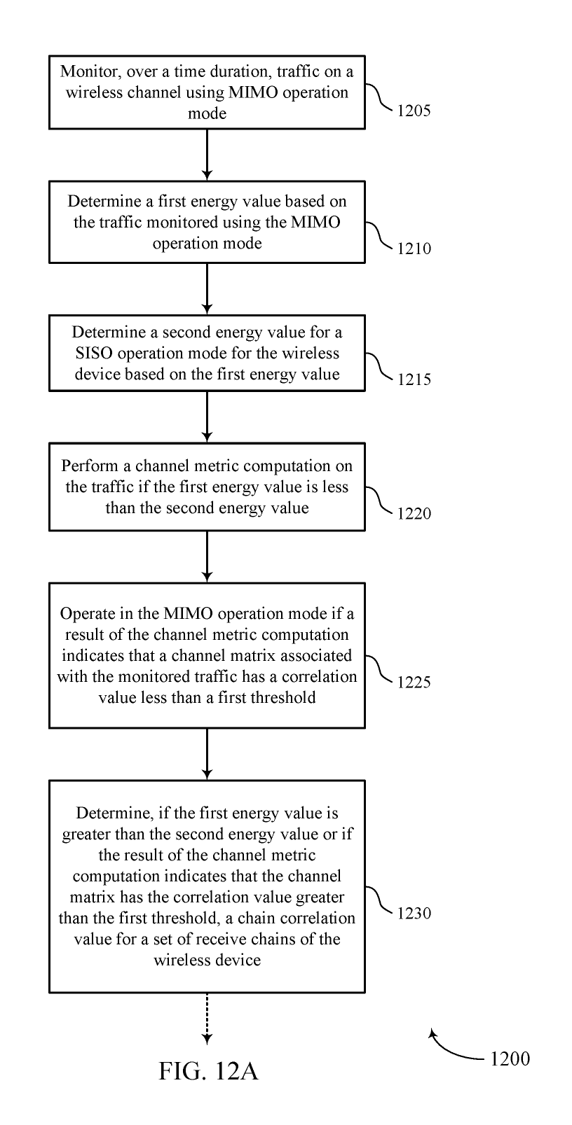

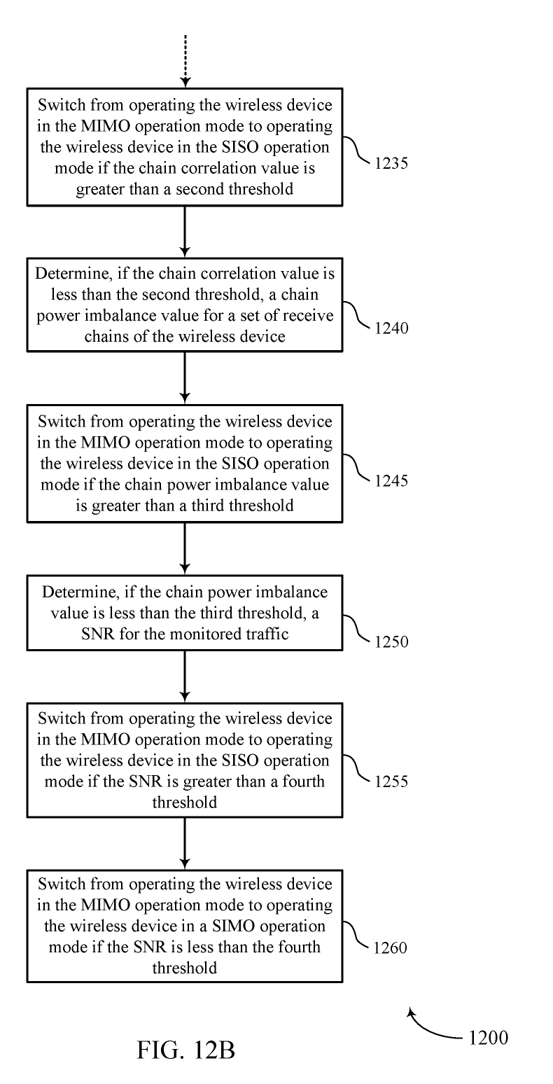

FIGS. 12A &12B show a flowchart illustrating a method 1200 for dynamic chain configuration selection in accordance with aspects of the present disclosure. The operations of method 1200 may be implemented by a STA 115 or its components as described herein. For example, the operations of method 1200 may be performed by a communications manager as described with reference to FIGS. 7 through 10. In some examples, a STA 115 may execute a set of codes to control the functional elements of the device to perform the functions described below. Additionally or alternatively, the STA 115 may perform aspects of the functions described below using special-purpose hardware.

At block 1205 the STA 115 may monitor, over a time duration, traffic on a wireless channel using MIMO operation mode. The operations of block 1205 may be performed according to the methods described herein. In certain examples, aspects of the operations of block 1205 may be performed by a traffic manager as described with reference to FIGS. 7 through 10.

At block 1210 the STA 115 may determine a first energy value based at least in part on the traffic monitored using the MIMO operation mode. The operations of block 1210 may be performed according to the methods described herein. In certain examples, aspects of the operations of block 1210 may be performed by a chain configuration energy manager as described with reference to FIGS. 7 through 10.

At block 1215 the STA 115 may determine a second energy value for a SISO operation mode for the wireless device based at least in part on the first energy value. The operations of block 1215 may be performed according to the methods described herein. In certain examples, aspects of the operations of block 1215 may be performed by a chain configuration energy manager as described with reference to FIGS. 7 through 10.

At block 1220 the STA 115 may perform a channel metric computation on the traffic if the first energy value is less than the second energy value. The operations of block 1220 may be performed according to the methods described herein. In certain examples, aspects of the operations of block 1220 may be performed by a channel correlator as described with reference to FIGS. 7 through 10.

At block 1225 the STA 115 may operate in the MIMO operation mode if a result of the channel correlation procedure indicates that a channel matrix associated with the monitored traffic has a correlation value less than a first threshold. The operations of block 1225 may be performed according to the methods described herein. In certain examples, aspects of the operations of block 1225 may be performed by a chain configuration manager as described with reference to FIGS. 7 through 10.

At block 1230 the STA 115 may determine, if the first energy value is greater than the second energy value or if the result of the channel metric computation indicates that the channel matrix has the correlation value greater than the first threshold, a chain correlation value for a plurality of receive chains of the wireless device. The operations of block 1230 may be performed according to the methods described herein. In certain examples, aspects of the operations of block 1230 may be performed by a chain configuration energy manager as described with reference to FIGS. 7 through 10.

At block 1235 the STA 115 may switch from operating the wireless device in the MIMO operation mode to operating the wireless device in the SISO operation mode if the chain correlation value is greater than a second threshold. The operations of block 1235 may be performed according to the methods described herein. In certain examples, aspects of the operations of block 1235 may be performed by a chain configuration manager as described with reference to FIGS. 7 through 10.

At block 1240 the STA 115 may determine, if the chain correlation value is less than the second threshold, a chain power imbalance value for a plurality of receive chains of the wireless device. The operations of block 1240 may be performed according to the methods described herein. In certain examples, aspects of the operations of block 1240 may be performed by a chain power imbalance manager as described with reference to FIGS. 7 through 10.

At block 1245 the STA 115 may switch from operating the wireless device in the MIMO operation mode to operating the wireless device in the SISO operation mode if the chain power imbalance value is greater than a third threshold. The operations of block 1245 may be performed according to the methods described herein. In certain examples, aspects of the operations of block 1245 may be performed by a chain configuration manager as described with reference to FIGS. 7 through 10.

At block 1250 the STA 115 may determine, if the chain power imbalance value is less than the third threshold, a signal-to-noise ratio (SNR) for the monitored traffic. The operations of block 1250 may be performed according to the methods described herein. In certain examples, aspects of the operations of block 1250 may be performed by a SNR manager as described with reference to FIGS. 7 through 10.

At block 1255 the STA 115 may switch from operating the wireless device in the MIMO operation mode to operating the wireless device in the SISO operation mode if the SNR is greater than a fourth threshold. The operations of block 1255 may be performed according to the methods described herein. In certain examples, aspects of the operations of block 1255 may be performed by a chain configuration manager as described with reference to FIGS. 7 through 10.

At block 1260 the STA 115 may switch from operating the wireless device in the MIMO operation mode to operating the wireless device in a SIMO operation mode if the SNR is less than the fourth threshold. The operations of block 1260 may be performed according to the methods described herein. In certain examples, aspects of the operations of block 1260 may be performed by a chain configuration manager as described with reference to FIGS. 7 through 10.

It should be noted that the methods described above describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, wireless communications system 100 and 200 of FIGS. 1 and 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. An apparatus for wireless communications at a wireless device, comprising:
a memory that stores instructions; and
a processor coupled with the memory, wherein the processor and the memory are configured to:
monitor, over a time duration, traffic on a wireless channel using a first chain configuration mode of the wireless device;
determine a first energy value based at least in part on the traffic monitored using the first chain configuration mode;
determine a second energy value for a second chain configuration mode of the wireless device based at least in part on the determined first energy value;
compare the determined first energy value to the determined second energy value;
perform a channel metric computation on the traffic; and
switch from operating the wireless device in the first chain configuration mode to operating the wireless device in the second chain configuration mode to communicate on the wireless channel based at least in part on the comparison and a result of the channel metric computation.

2. The apparatus of claim 1, wherein the processor and the memory are further configured to:
determine that the result of the channel metric computation is less than a threshold, wherein switching from operating the wireless device in the first chain configuration mode to operating the wireless device in the second chain configuration mode is based at least in part on the determination that the result of the channel metric computation is less than the threshold.

3. The apparatus of claim 2, wherein:
the first chain configuration mode comprises one of a single-input single output (SISO) operation mode, a single-input multiple-output (SIMO) operation mode, or a multiple-input multiple-output (MIMO) operation mode; and
the second chain configuration mode comprises another of the SISO operation mode, the SIMO operation mode, or the MIMO operation mode.

4. The apparatus of claim 1, wherein the processor and the memory are configured to perform the channel metric computation by being further configured to:
compute eigenvalues of a channel matrix;
compute a ratio of a maximum eigenvalue to a minimum eigenvalue; and
determine a channel condition number based at least in part on the ratio.

5. The apparatus of claim 1, wherein the processor and the memory are configured to perform the channel metric computation by being further configured to:
compute eigenvalues of a channel matrix;
compute a QR decomposition of the channel matrix for the wireless device;
identify an R-matrix based at least in part on the QR decomposition; and
determine a channel orthogonality based at least in part on elements of the identified R-matrix.

6. The apparatus of claim 1, wherein the processor and the memory are further configured to:
sub-sample one or more tones from a plurality of tones of the monitored traffic; and
determine a wireless channel metric based at least in part on the sub-sampled one or more tones, wherein the wireless channel metric is a channel condition number.

7. The apparatus of claim 6, wherein the processor and the memory are further configured to:
determine a channel frequency coherence for the wireless channel; and
select a set of the one or more tones to be sampled from the plurality of tones based at least in part on the determined channel coherence.

8. The apparatus of claim 1, wherein the processor and the memory are configured to determine the second energy value by being further configured to:
determine, for the first chain configuration mode, a first receive duration for the monitored traffic, the first energy value being determined based at least in part on the first receive duration;
determine, for the second chain configuration mode, a second receive duration for the monitored traffic based at least in part on the first receive duration; and
determine the second energy value for the monitored traffic based at least in part on the second receive duration.

9. The apparatus of claim 1, wherein the processor and the memory are configured to determine, for the first chain configuration mode, the first energy value for the monitored traffic by being further configured to:
determine, for the first chain configuration mode, one or more of a listen power, a listen duration, a receive power, a receive duration, a sleep power, and a sleep duration for the monitored traffic during the time duration; and
determine the first energy value for the monitored traffic based at least in part on one or more of the listen duration, the listen power, the receive duration, the receive power, the sleep duration, and the sleep power.

10. The apparatus of claim 1, wherein the processor and the memory are further configured to:
determine a chain correlation value for a plurality of receive chains of the wireless device, wherein switching from operating the wireless device in the first chain configuration mode to operating the wireless device in the second chain configuration mode is further based at least in part on the determined chain correlation value.

11. The apparatus of claim 10, wherein the processor and the memory are further configured to:
determine that the chain correlation value exceeds a threshold, wherein switching from operating the wireless device in the first chain configuration mode to operating the wireless device in the second chain configuration mode is further based at least in part on the determination that the chain correlation value exceeds the threshold.

12. The apparatus of claim 1, wherein the processor and the memory are further configured to:
determine a chain power imbalance value for a plurality of receive chains of the wireless device, wherein switching from operating the wireless device in the first chain configuration mode to operating the wireless device in the second chain configuration mode is further based at least in part on the determined chain power imbalance value; and
determine that the chain power imbalance value exceeds a threshold, wherein switching from operating the wireless device in the first chain configuration mode to operating the wireless device in the second chain configuration mode is further based at least in part on the determination that the chain power imbalance value exceeds the threshold.

13. The apparatus of claim 1, wherein the processor and the memory are further configured to:
determine a signal-to-noise ratio (SNR) for the monitored traffic, wherein switching from operating the wireless device in the first chain configuration mode to operating the wireless device in the second chain configuration mode is further based at least in part on the determined SNR; and
determine that the SNR exceeds a threshold, wherein switching from operating the wireless device in the first chain configuration mode to operating the wireless device in the second chain configuration mode is further based at least in part on the determination that the SNR exceeds the threshold.

14. The apparatus of claim 1, wherein the processor and the memory are further configured to:
determine a signal-to-noise ratio (SNR) for the monitored traffic, wherein switching from operating the wireless device in the first chain configuration mode to operating the wireless device in the second chain configuration mode is further based at least in part on the determined SNR; and
determine that the SNR is less than a threshold, wherein switching from operating the wireless device in the first chain configuration mode to operating the wireless device in the second chain configuration mode is further based at least in part on the determination that the SNR is less than the threshold.

15. An apparatus for wireless communications at a wireless device, comprising:
a memory that stores instructions; and
a processor coupled with the memory, wherein the processor and the memory are configured to:
monitor, over a time duration, traffic on a wireless channel using a multiple-input multiple-output (MIMO) operation mode;
determine a first energy value based at least in part on the traffic monitored using the MIMO operation mode;
determine a second energy value for a single-input single-output (SISO) operation mode for the wireless device based at least in part on the first energy value;
perform a channel metric computation on the traffic if the first energy value is less than the second energy value;
operate in the MIMO operation mode if a result of the channel metric computation indicates that a channel matrix associated with the monitored traffic has a correlation value less than a first threshold;
determine, if the first energy value is greater than the second energy value, or if the result of the channel metric computation indicates that the channel matrix has the correlation value greater than the first threshold, a chain correlation value for a plurality of receive chains of the wireless device;
switch from operating the wireless device in the MIMO operation mode to operating the wireless device in the SISO operation mode if the chain correlation value is greater than a second threshold;
determine, if the chain correlation value is less than the second threshold, a chain power imbalance value for the plurality of receive chains of the wireless device;
switch from operating the wireless device in the MIMO operation mode to operating the wireless device in the SISO operation mode if the chain power imbalance value is greater than a third threshold;
determine, if the chain power imbalance value is less than the third threshold, a signal-to-noise ratio (SNR) for the monitored traffic;
switch from operating the wireless device in the MIMO operation mode to operating the wireless device in the SISO operation mode if the SNR is greater than a fourth threshold; and
switch from operating the wireless device in the MIMO operation mode to operating the wireless device in a single-input multiple-output (SIMO) operation mode if the SNR is less than the fourth threshold.

16. A method for wireless communications at a wireless device, comprising:
monitoring, over a time duration, traffic on a wireless channel using a first chain configuration mode of the wireless device;
determining a first energy value based at least in part on the traffic monitored using the first chain configuration mode;
determining a second energy value for a second chain configuration mode of the wireless device based at least in part on the determined first energy value;
comparing the determined first energy value to the determined second energy value;
performing a channel metric computation on the traffic; and
switching from operating the wireless device in the first chain configuration mode to operating the wireless device in the second chain configuration mode to communicate on the wireless channel based at least in part on the comparison and a result of the channel metric computation.

17. The method of claim 16, further comprising:
determining that the result of the channel metric computation is less than a threshold, wherein switching from operating the wireless device in the first chain configuration mode to operating the wireless device in the second chain configuration mode is based at least in part on the determination that the result of the channel metric computation is less than the threshold.

18. The method of claim 17, wherein:
the first chain configuration mode comprises one of a single-input single output (SISO) operation mode, a single-input multiple-output (SIMO) operation mode, or a multiple-input multiple-output (MIMO) operation mode; and
the second chain configuration mode comprises another of the SISO operation mode, the SIMO operation mode, or the MIMO operation mode.

19. The method of claim 16, wherein performing the channel metric computation comprises:
computing eigenvalues of a channel matrix;
computing a ratio of a maximum eigenvalue to a minimum eigenvalue; and
determining a channel condition number based at least in part on the ratio.

20. The method of claim 16, wherein performing the channel metric computation comprises:
computing eigenvalues of a channel matrix;
computing a QR decomposition of the channel matrix for the wireless device;
identifying an R-matrix based at least in part on the QR decomposition; and
determining a channel orthogonality based at least in part on elements of the identified R-matrix.

21. The method of claim 16, further comprising:
sub-sampling one or more tones from a plurality of tones of the monitored traffic; and
determining a wireless channel metric based at least in part on the sub-sampled one or more tones, wherein the wireless channel metric is a channel condition number.

22. The method of claim 21, further comprising:
determining a channel frequency coherence for the wireless channel; and
selecting a set of the one or more tones to be sampled from the plurality of tones based at least in part on the determined channel coherence.

23. The method of claim 16, wherein the determining the second energy value further comprises:
determining, for the first chain configuration mode, a first receive duration for the monitored traffic, the first energy value being determined based at least in part on the first receive duration.

24. The method of claim 16, wherein determining, for the first chain configuration mode, the first energy value for the monitored traffic comprises:
determining, for the first chain configuration mode, one or more of a listen power, a listen duration, a receive power, a receive duration, a sleep power, and a sleep duration for the monitored traffic during the time duration; and
determining the first energy value for the monitored traffic based at least in part on one or more of the listen duration, the listen power, the receive duration, the receive power, the sleep duration, and the sleep power.

25. The method of claim 16, further comprising:
determining a chain correlation value for a plurality of receive chains of the wireless device, wherein switching from operating the wireless device in the first chain configuration mode to operating the wireless device in the second chain configuration mode is further based at least in part on the determined chain correlation value.

26. The method of claim 25, further comprising:
determining that the chain correlation value exceeds a threshold, wherein switching from operating the wireless device in the first chain configuration mode to operating the wireless device in the second chain configuration mode is further based at least in part on the determination that the chain correlation value exceeds the threshold.

27. The method of claim 16, further comprising:
determining a chain power imbalance value for a plurality of receive chains of the wireless device, wherein switching from operating the wireless device in the first chain configuration mode to operating the wireless device in the second chain configuration mode is further based at least in part on the determined chain power imbalance value; and
determining that the chain power imbalance value exceeds a threshold, wherein switching from operating the wireless device in the first chain configuration mode to operating the wireless device in the second chain configuration mode is further based at least in part on the determination that the chain power imbalance value exceeds the threshold.

28. The method of claim 16, further comprising:
determining a signal-to-noise ratio (SNR) for the monitored traffic, wherein switching from operating the wireless device in the first chain configuration mode to operating the wireless device in the second chain configuration mode is further based at least in part on the determined SNR; and
determining that the SNR exceeds a threshold, wherein switching from operating the wireless device in the first chain configuration mode to operating the wireless device in the second chain configuration mode is further based at least in part on the determination that the SNR exceeds the threshold.

29. The method of claim 16, further comprising:
determining a signal-to-noise ratio (SNR) for the monitored traffic, wherein switching from operating the wireless device in the first chain configuration mode to operating the wireless device in the second chain configuration mode is further based at least in part on the determined SNR; and
determining that the SNR is less than a threshold, wherein switching from operating the wireless device in the first chain configuration mode to operating the wireless device in the second chain configuration mode is further based at least in part on the determination that the SNR is less than the threshold.

30. A method for wireless communications at a wireless device, comprising:
monitoring, over a time duration, traffic on a wireless channel using a multiple-input multiple-output (MIMO) operation mode;
determining a first energy value based at least in part on the traffic monitored using the MIMO operation mode;
determining a second energy value for a single-input single-output (SISO) operation mode for the wireless device based at least in part on the first energy value;
performing a channel metric computation on the traffic if the first energy value is less than the second energy value;
operating in the MIMO operation mode if a result of the channel metric computation indicates that a channel matrix associated with the monitored traffic has a correlation value less than a first threshold;
determining, if the first energy value is greater than the second energy value, or if the result of the channel metric computation indicates that the channel matrix has the correlation value greater than the first threshold, a chain correlation value for a plurality of receive chains of the wireless device;
switching from operating the wireless device in the MIMO operation mode to operating the wireless device in the SISO operation mode if the chain correlation value is greater than a second threshold;
determining, if the chain correlation value is less than the second threshold, a chain power imbalance value for the plurality of receive chains of the wireless device;
switching from operating the wireless device in the MIMO operation mode to operating the wireless device in the SISO operation mode if the chain power imbalance value is greater than a third threshold;
determining, if the chain power imbalance value is less than the third threshold, a signal-to-noise ratio (SNR) for the monitored traffic;
switching from operating the wireless device in the MIMO operation mode to operating the wireless device in the SISO operation mode if the SNR is greater than a fourth threshold; and
switching from operating the wireless device in the MIMO operation mode to operating the wireless device in a single-input multiple-output (SIMO) operation mode if the SNR is less than the fourth threshold.
